(19) United States
(12) Patent Application Publication
(10) Pub. No.: US 2013/0337676 A1
(43) Pub. Date: Dec. 19, 2013

(54) Cable Connector

(71) Applicant: ANT PRECISION INDUSTRY CO., LTD., Taipei City (TW)

(72) Inventor: Chih-yu Hsueh, Taipei City (TW)

(73) Assignee: ANT PRECISION INDUSTRY CO., LTD., Taipei City (TW)

(21) Appl. No.: 13/911,124

(22) Filed: Jun. 6, 2013

Related U.S. Application Data
(60) Provisional application No. 61/656,985, filed on Jun. 7, 2012.

(30) Foreign Application Priority Data
Sep. 7, 2012 (TW) 101217405
Nov. 1, 2012 (TW) 101221198

(51) Int. Cl. H01R 13/627

(52) U.S. Cl. CPC H01R 13/6275
USPC 439/350; 439/626

(57) ABSTRACT

A cable connector is introduced herein, which includes a conductive shell, a plurality of rows of terminals and at least one insulated body, wherein an elastic contact section formed on each of the terminals is extended into a central slot of the at least one insulated body to electrically contact with an electronic device, and the conductive shell is positioned outside the at least one insulated body and has at least one grounding finger extended toward at least one passage in the at least one insulated body and thereby being electrically connected with either the elastic contact section or a soldering section of corresponding terminal accommodated within the at least one passage.

### CROSS REFERENCE TO RELATED APPLICATION

This patent application claims priority of U.S. Provisional Application Ser. No. 61/656,985, entitled “CABLE CONNECTOR”, which is filed on Jun. 7, 2012, incorporated herein by reference.

### BACKGROUND OF THE INVENTION

1. Field of the Invention

The present invention relates to a cable connector, and more particularly to a cable connector that is convenient to assemble and repair.

2. Description of Prior Art

As technological aspect and functions of various kinds of digital products such as a computer, a smart phone, a digital television, a tablet computer, and a digital camera are being continuously developed, with the demanded amounts of accessing digital information being increasing day by day, the storage devices for said digital products become more slim and lightweight while having a huger data storage volume and faster speeds of accessing and processing digital information. To transmit the digital information, a common use is cable connectors establishing an electrical connection between an electronic product and the storage device thereof. To meet the compact design of different various electronic products or storage devices, the whole structures of conventional cable connectors trends to miniature size as well as leading to the following problems.

(1) Due to miniaturization of the conventional cable connector, the pitches among a plurality of different terminals attached to a cable connector become narrower. Hence, during its assembling process, a soldering operation of every terminal and its corresponding cable is greatly inconvenient. For example, a solder used for the soldering process is more possibly stained to the adjacent terminals to invoke an electrical shortage or a space for soldering operation is insufficient.

(2) When being soldered to its corresponding cable, a soldering leg section of each terminal is possibly forced to shift in causing the soldering operation inconvenient and inaccurate, wherein if an irreparable defect occurs in any one of the terminals, such as mis-soldering, the entire cable connector would be defective product as scrapped.

(3) If a shielding structure in a conventional cable connector is poorly designed, the cable connector is vulnerable to external signal interference such as electro-static discharge (ESD) or electro-magnetic interference (EMI) when the plurality of terminals are connected to a power source and transmit signals, respectively.

### SUMMARY OF THE INVENTION

Accordingly, to resolve the above-mentioned problems one objective of the present invention is to provide a cable connector, structures in assembly of which can not only conveniently quicken the assembly thereof but can also prevent a soldering section of each of its terminals from being shifted when the corresponding cable is soldered thereon to force, this increases a convenience and reliability of its soldering operation.

Another objective of the present invention is to provide a cable connector, a whole after-assembled structure of which can not only avoid loosing but also create a better ESD or EMI shielding effect.

Another objective of the present invention is to provide a cable connector which, by a plurality of detachable insulated bodies, can process the soldering of different rows of terminals either simultaneously or separately, so as to not only conveniently quicken an assembly of the cable connector but also merely replace the corresponding one of the insulated bodies in which if one of its terminals has a irreparable problem. It is easy to repair and thereby raise yield rate and lower manufacturing cost.

To attain the objectives, a preferred embodiment according to the present invention is to provide a cable connector for electrically connecting to an electronic device. The cable connector comprises a conductive shell, a plurality of rows of terminals and at least one insulated body, wherein in the plurality of rows of terminals, each of the terminals has an elastic contact section, at least one retaining section and a soldering section. The at least one insulated body is formed with a flat portion having a first end, a second end opposite to the first end, a central slot extended inwardly from the first end of the flat portion, and a plurality of rows of passages extended between the first end and second end to correspondingly accommodate the rows of terminals, wherein the central slot has an internal space for accommodating a portion of the electronic device, and each of the elastic contact sections of the rows of terminals is extended into the central slot to electrically contact with the electronic device. The conductive shell is disposed outside the at least one insulated body and has at least one grounding finger extended towards at least one of the passages of the at least one insulated body, thereby electrically connecting to the corresponding terminal accommodated in the at least one of the passages.

In one of the preferred embodiments according to the present invention, the cable connector further comprises a cover which has a plurality of side walls respectively formed on both sides of the cover. An accommodating space defined jointly by combining the cover with the conductive shell provides an electrical connection between the soldering sections of the rows of terminals and a corresponding cable, wherein by at least one engaging unit at least one of the side walls of the cover is engaged onto one of side walls of the at least one insulated body so as to dispose the conductive shell in between the at least one insulated body and the cover, and the at least one engaging unit comprises at least one pair of structurally complementary protrusive section and notch section, thereby combining one of the side walls of the cover with one of the side walls of the at least one insulated body to define a through hole for the corresponding cable passing through.

In one of the preferred embodiments according to the present invention, the cable connector further comprises a cover formed with a plurality of side walls and combined with the conductive shell to define an accommodating space for providing an electrical connection between the soldering sections of rows of terminals and the corresponding wires, wherein by engaging at least one of the side walls of the cover to the conductive shell one of the side walls of the cover is combined with one of side walls of the conductive shell to define a through hole for the corresponding cable passing through.

In one of the preferred embodiments according to the present invention, an undulating connecting section is formed between the at least one retaining section and the soldering section in each of the terminals, so that the two lateral sides of the soldering section respectively abut against two opposite cornered slots respectively formed on both sidewalls of the corresponding passage to support the soldering section of the corresponding terminal.

In one of the preferred embodiments according to the present invention, the conductive shell is provided to electrically shield the cable connector. The at least one grounding finger of the conductive shell is extended into a corresponding aperture of the at least one insulated body, thereby electrically contact with the elastic contact section of the corresponding terminal, and at least one securing portion is formed on the conductive shell to be engaged to the first end of the at least one insulated body.

In one of the preferred embodiments according to the present invention, said at least one insulated body is a first insulated body, and the cable connector is further provided with a second insulated body disposed on the second end of the first insulated body, and a depression defined jointly by the two opposed side walls and the flat portion of the first insulated body to accommodate the second insulated body. A portion of the second insulated body is provided to support the soldering sections of the corresponding terminals accommodated in the rows of passages.

In one of the preferred embodiments according to the present invention, the soldering section of the corresponding terminal accommodated within at least one of said passages electrically contacts with the at least one grounding finger of the conductive shell.

In one of the preferred embodiments according to the present invention, said at least one insulated body is a first insulated body, and the cable connector further comprises a second insulated body which is disposed between the first insulated body and the conductive shell and has two opposed side walls each formed with an extending surface to support the soldering sections of the corresponding terminals extending outward from an end of the corresponding passages of the first insulated body, wherein at least one of the side walls of the second insulated body is engaged to the flat portion of the first insulated body by a first engaging unit, and the conductive shell has at least one securing portion for engagement with the second insulated body. Furthermore, the cable connector comprises a cover has a plurality of side walls respectively formed on both sides of the cover. An accommodating space is defined jointly by combining the cover with the conductive shell so as to provide an electrical connection between the soldering sections of the rows of terminals and the corresponding cable, wherein at least one of the side walls of the cover is engaged onto one of the side walls of the first insulated body by a second engaging unit so as to dispose the second insulated body and the conductive shell in between the first insulated body and the cover. Each of said engaging units comprises at least one pair of structurally complementary protrusive section and notch section, thereby combining one of the side walls of the cover with one of the side walls of the first insulated body to define a through hole for the corresponding cable passing through.

In one of the preferred embodiments according to the present invention, said at least one insulated body is a first insulated body, and the cable connector further comprises a second insulated body disposed on the first insulated body and has an end formed with a plurality of supporting bumps, each of which is inserted into the corresponding passage of the flat portion to support the soldering section of the corresponding terminal accommodated in the corresponding passage, wherein two opposed side wall of the second insulated body is engaged to two opposed side walls of the first insulated body by at least one engaging unit which comprises at least one pair of structurally complementary protrusive section and notch section, and the conductive shell has at least one securing portion to be engaged onto the corresponding side wall of the first insulated body.

In addition, the present invention further provides a cable connector for electrically connecting to an electronic device. The cable connector comprises a conductive shell a plurality of rows of terminals, a first insulated body and a second insulated body, wherein in the plurality of rows of terminals, each of the terminals has an elastic contact section, at least one retaining section and a soldering section. The first insulated body forms a flat portion having a first end, a second end opposed to the first end, a central slot extended inward from the first end of the flat portion, and a plurality of rows of passages extended between the first end and the second end to correspondingly accommodate the rows of terminals in which each of the elastic contact sections is extended into the central slot so as to electrically contact with the electronic device. The second insulated body is disposed on the second end of the first insulated body, and a portion of the second insulated body is provided to support an electrical connection between the soldering sections of the corresponding terminals accommodated in the rows of passages and a corresponding cable.

In one of the preferred embodiments according to the present invention, a spring latching arm is formed on one of side walls of the first insulated body for engagement with a corresponding hole on the electronic device.

In one of the preferred embodiments according to the present invention, the second insulated body is engaged onto the two opposed side walls or the flat portion of the first insulated body.

In one of the preferred embodiments according to the present invention, a portion of the second insulated body comprises a plurality of supporting bumps formed on an end of the second insulated body, each of which is inserted into the corresponding passage of the flat portion to support the soldering section of the corresponding terminal accommodated within the corresponding passage.

In one of the preferred embodiments according to the present invention, a portion of the second insulated body comprises at least one extending surface formed on a side wall of the second insulated body to support the soldering section of the corresponding terminal extended outward from an end of the corresponding passage.

In one of the preferred embodiments according to the present invention, the cable connector further comprises a conductive shell engaged onto either the first insulated body or the second insulated body, and the conductive shell has at least one grounding finger extended towards at least one of passages of the first insulated body to electrically contact with the corresponding terminal accommodated in the at least one passage.

In addition, the present invention further provides an electrical apparatus which comprises the cable connectors in the above-mentioned preferred embodiments.

Based on the utilization of the engaging units with the cable connector according to the present invention, these components, e.g. the insulated bodies, the cover, of the cable connector can be assembled conveniently and quickly. When each of the corresponding wires is soldered to the soldering section of each of the terminals, with supporting of the cornered slots of the corresponding passages of the at least one insulated body or the extending surface or supporting bump of the second insulated body, the soldering section is prevented from being shifted while forced, thereby improving handiness and accuracy for the soldering operation. By the at least one grounding finger of the conductive shell electrically contacting with the elastic contact section or soldering section of one of terminals which is electrically connected to the corresponding grounding wire in at least one of the insulated bodies, a preferable shielding protection is formed for the cable connector to prevent an external signal interferences such as an ESD or EMI.

To attain the objectives, a preferred embodiment according to the present invention is to provide a cable connector utilized for electrically connecting to an electronic device. The cable connector comprises a conductive shell, a plurality of rows of terminals, a plurality of detachable insulated bodies and at least one engaging unit.

Each of the terminals in rows is provided with an elastic contact section, a plurality of retaining sections and a soldering section, wherein a coplanar connection is formed between the at least one retaining section and the soldering section.

Each of the insulated bodies has a flat portion which is formed with an extending surface and a row of passages connected to the extending surface and accommodating a row of corresponding terminals, the soldering section of each of which is exposed outward the extending surface. Each of the insulated bodies has two side walls respectively formed on both sides of the flat portion. A depression is defined jointly by the two side walls in combination with the extending surface of flat portion, so as to facilitate the electrical connection between the soldering sections of the rows of terminals and the corresponding wires. One of the side walls of one of the insulated bodies, and another side wall of another one of the insulated bodies corresponds to each other and individually form an opening. When the insulated bodies are assembled, the openings define a through hole jointly for the corresponding cable passing through. After the insulated bodies are assembled, the extending surfaces of the insulated bodies are opposed apart away from each other and jointly define an accommodating space therebetween for accommodating the connection between the soldering sections of the rows of terminals and the corresponding cable. With utilizations of the separated insulated bodies according to the present invention, the soldering operations of different rows of terminals can be processed simultaneously or separately. This will conveniently quicken the assembling of the cable connector, and if any irreparable problem occurs in one of the terminals, it is only required to replace the corresponding insulated body and the repair becomes easy, thereby raising the yield rate and reducing the manufacturing cost.

The at least one engaging unit is disposed on at least one of the insulated bodies and comprises a protrusive section and a notch section both which are complementary structurally and respectively formed on the side wall in at least one of the insulated bodies. By the at least one engaging unit, the insulated bodies are assembled to define a central slot for accommodating a portion of the electronic device in between the flat portions of the insulated bodies, and extending each of the elastic contact sections of the rows of terminals into the central slot to electrically contact with the electronic device.

The conductive shell is formed with at least one securing portion, a spring latching arm and at least one grounding finger, wherein the spring latching arm is engaged to a hole of the electronic device while the conductive shell is disposed on the assembled insulated bodies. By the at least one engaging unit, the assembled insulated bodies forms a recess thereon for insertion of the securing portion of the conductive shell. One of the insulated bodies is provided with a latching arm support section and at least one aperture. The latching arm support section is provided to support the spring latching arm of the conductive shell, and the at least one aperture is provided for the at least one grounding finger extending thereto so as to electrically contact with the elastic contact section of at least one of the terminals within the insulated bodies, by electrically connecting a corresponding grounding wire to the at least one of the terminals, thereby establishing a shielding protection for the cable connector to prevent an external signal interferences such as an ESD or EMI.

The cable connector according to the present invention further comprises a cover provided for covering the accommodating space.

Besides, in order to attain the above-mentioned objectives, a preferred embodiment of the present invention is to provide a cable connector which is distinguished from the previous embodiment as follows. In the preferred embodiment an undulating connecting section is formed between the at least one retaining section and the soldering section of each of the terminals of the cable connector so that the left and right sides of the soldering section respectively abut against the two corresponding cornered slots formed on both sidewalls of the corresponding passage, so as to facilitate a soldering operation of the soldering section of each of the terminals and prevent the soldering material from flowing to the adjacent terminals and causing a shorting circuit, and the passages are arranged on the extending surface of the flat portion. After the insulated bodies are assembled, the extending surfaces of the insulated bodies are attached to each other back-to-back and the side walls of the insulated bodies jointly define an accommodating space to accommodate the connection between the soldering sections of the rows of terminals and the corresponding cable. The row of passages of each of the insulated bodies are connected to the extending surface, and a latching arm support section is formed on at least one of the insulated bodies, and the afore-mentioned insulated bodies are assembled to form a recess. When the conductive shell is disposed onto the assembled insulated bodies, a securing portion formed on the conductive shell is inserted into the corresponding recess, and the spring latching arm of the conductive shell is supported by the latching arm support section.

### BRIEF DESCRIPTION OF THE DRAWINGS

FIG. 1A is an exploded front diagram of a cable connector in a first preferred embodiment according to the present invention;

FIG. 1B is an exploded rear diagram of the cable connector in the first preferred embodiment according to the present invention;

FIG. 1C is a perspective diagram of the after-assembled first and second insulated bodies of the first preferred embodiment according to the present invention;

FIG. 1D is a perspective diagram of completely assembled cable connector in the first preferred embodiment according to the present invention;

FIG. 2A is a schematic diagram of the cable connector in the first preferred embodiment according to the present invention, which is being electrically connected to an electronic device;

FIG. 2B is a schematic diagram of the cable connector in the first preferred embodiment according to the present invention, which has been electrically connected to the electronic device;

FIG. 2C is a front diagram of the cable connector in the first preferred embodiment according to the present invention, which has been electrically connected to the electronic device;

FIG. 2D is a cross-sectional view along a D-D′ cutting line according to FIG. 2C;

FIG. 2E is a cross-sectional view along a E-E′ cutting line according to FIG. 2C;

FIG. 2F is a cross-sectional view along a F-F′ cutting line according to FIG. 2B;

FIG. 2G is a cross-sectional view along a G-G′ cutting line according to FIG. 2C;

FIG. 3A is an exploded rear diagram of a cable connector in a second preferred embodiment according to the present invention;

FIG. 3B is an exploded front diagram of the cable connector in the second preferred embodiment according to the present invention;

FIG. 3C is a front view of the cable connector in the second embodiment according to the present invention, which is electrically connected to an electronic device;

FIG. 3D is a cross-sectional view along a D-D′ cutting line according to FIG. 3C;

FIG. 3E is a cross-sectional view along a E-E′ cutting line according to FIG. 3C;

FIG. 4A is an exploded rear diagram of a cable connector in a third preferred embodiment according to the present invention;

FIG. 4B is an exploded front diagram of the cable connector in the third preferred embodiment according to the present invention;

FIG. 4C is a perspective diagram of the after-assembled first and second insulated bodies in the third preferred embodiment according to the present invention;

FIG. 4D is a perspective diagram of assembling the first and second insulated bodies and the conductive shell in the third preferred embodiment according to the present invention;

FIG. 4E is a perspective diagram of the assembled cable connector in the third preferred embodiment according to the present invention;

FIG. 4F is a cross-sectional diagram of the cable connector in the third preferred embodiment according to the present invention, which is being electrically connected to the electronic device;

FIG. 5 is an exploded rear diagram of a cable connector in a forth preferred embodiment according to the present invention;

FIG. 6A is an exploded rear diagram of a cable connector in a fifth preferred embodiment according to the present invention;

FIG. 6B is an exploded diagram of a cable connector in the fifth preferred embodiment according to the present invention;

FIG. 6C is a perspective diagram of assembling the first insulated body and the first row of terminals, and assembling the second insulated body and the second row of terminals in the fifth preferred embodiment according to the present invention, wherein the first insulated body is rotated at 180°;

FIG. 6D is a perspective diagram of assembling the first and second insulated bodies and the wires in the fifth preferred embodiment according to the present invention;

FIG. 6E is a perspective diagram of assembling the cable connector and the conductive shell thereof in the fifth preferred embodiment according to the present invention;

FIG. 6F is a perspective diagram of the completely assembled cable connector in the fifth preferred embodiment according to the present invention;

FIG. 7A is a schematic diagram of the cable connector in the fifth preferred embodiment according to the present invention, which is electrically connected to an electronic device;

FIG. 7B is a schematic diagram of the cable connector in the fifth preferred embodiment according to the present invention, which has been electrically connected to an electronic device;

FIG. 7C is a longitudinal cross-sectional view along a C-C′ cutting line according to FIG. 7B;

FIG. 7D is a horizontal cross-sectional view along a D-D′ cutting line according to FIG. 7B;

FIG. 8A is an exploded rear diagram of a cable connector in a sixth preferred embodiment according to the present invention;

FIG. 8B is an exploded front diagram of the cable connector in the sixth preferred embodiment according to the present invention;

FIG. 8C is a perspective diagram of assembling the first insulated body and the first row of terminals and assembling the second insulated body and the second row of terminals in the sixth preferred embodiment according to the present invention;

FIG. 8D is a perspective diagram of assembling the first and second insulated bodies and the wires in the sixth preferred embodiment according to the present invention;

FIG. 8E is a perspective diagram of assembling the cable connector and the conductive shell thereof in the sixth preferred embodiment according to the present invention; and

FIG. 9 is a longitudinal cross-sectional diagram of the cable connector in the sixth preferred embodiment according to the present invention, which is electrically connected to the electronic device.

### DETAILED DESCRIPTION OF THE INVENTION

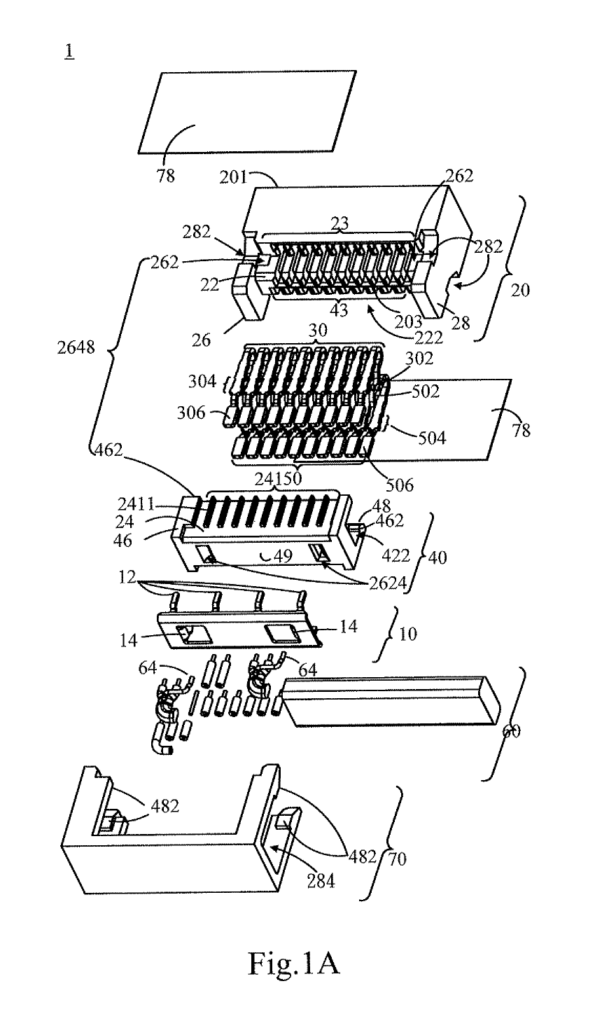

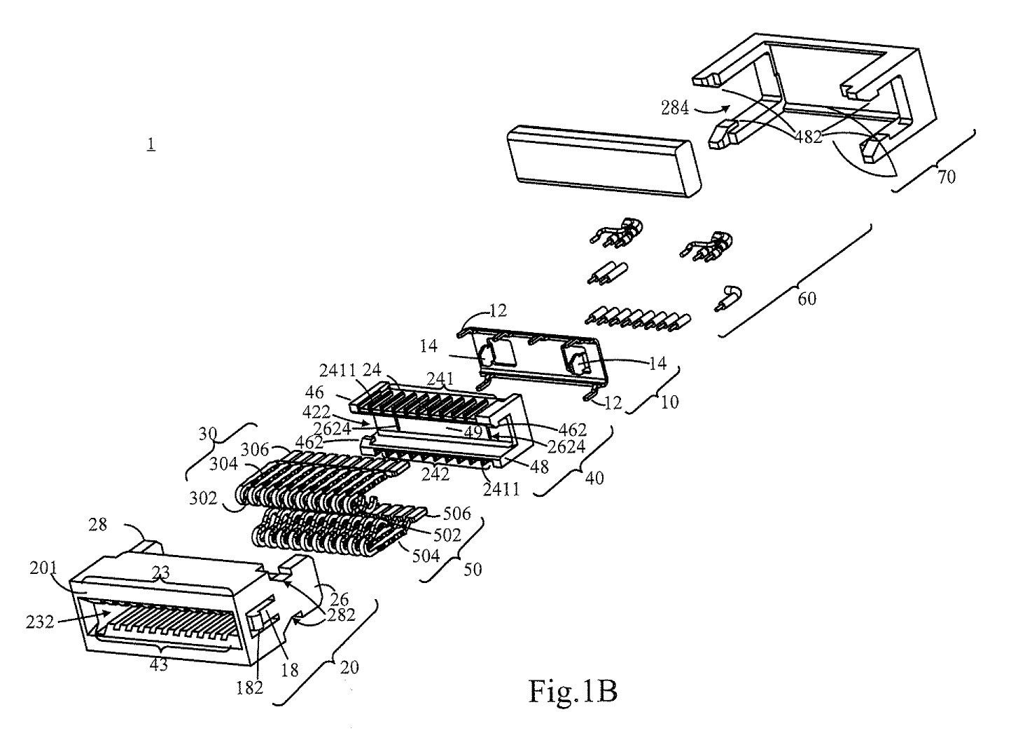

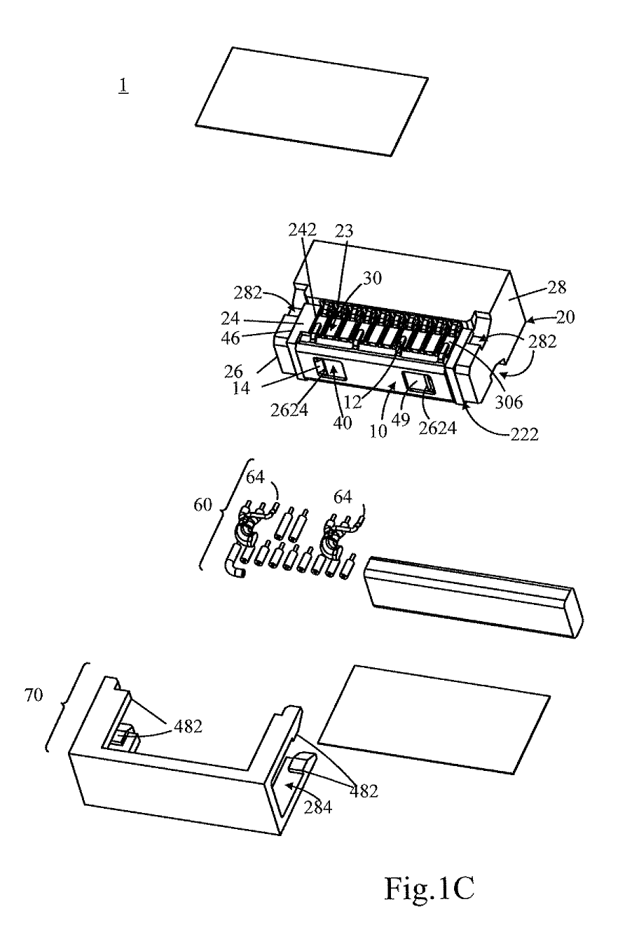

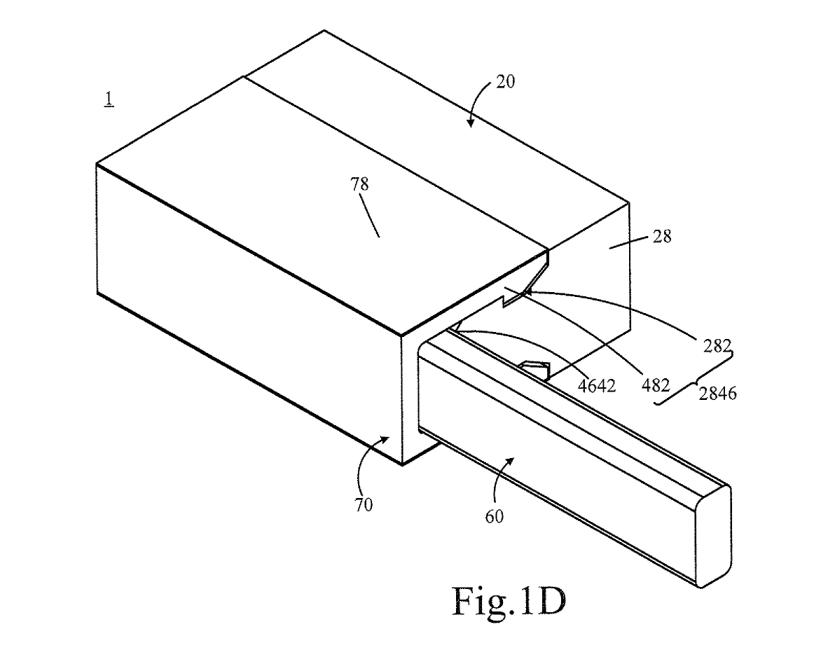

Please refer to FIG. 1A, FIG. 1A illustrates a cable connector 1 in a first embodiment according to the present invention and comprising a conductive shell 10, two detachable insulated bodies which are a first insulated body 20 and a second insulated body 40, a first row of terminals 30, a second row of terminals 50, a cable 60 containing a bunch of wires, a cover 70 and a pair of patches 78.

As illustrated in FIGS. 1A and 1B, a flat portion 22 is extended horizontally and formed on the first insulated body 20 and comprises a first end 201, a second end 203 opposed to the first end 201, a central slot 232 extended from the first end 201 of the flat portion 22 toward the inside of the first insulated body 20, and a first row of passages 23 and a second row of passages 43, where the passages 23, 43 are formed respectively between the first end 201 and the second end 203. The first row of passages 23 and the second row of passages 43 are extended horizontally from two opposed side walls, top and bottom, of the central slot 232 to a top and a bottom surfaces of the flat portion 22 and thereby accommodates the plurality of row of terminals 30 and 50 therein, respectively. A depression 222 is defined jointly by two opposed left side wall 26 and right side wall 28 in combination with the flat portion 22. As illustrated by FIG. 1A, two first notch sections 262 are formed respectively on two opposed ends of each of the two top and bottom surfaces of the flat portion 22, and two second dents 282 are formed respectively on two top and bottom surfaces of each of the left and right side walls 26, 28. Also, as illustrated in FIG. 1B, a spring latching arm 18 having a lateral resilience is integrally formed on the left side wall 26, and a clamping portion 182 is formed on a front end of the latching arm 18.

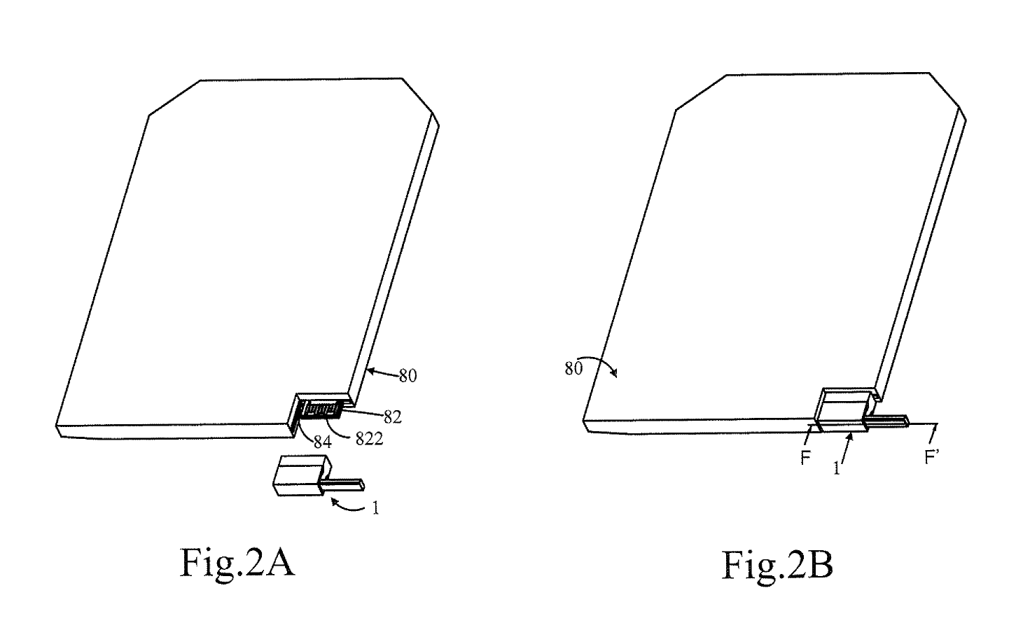

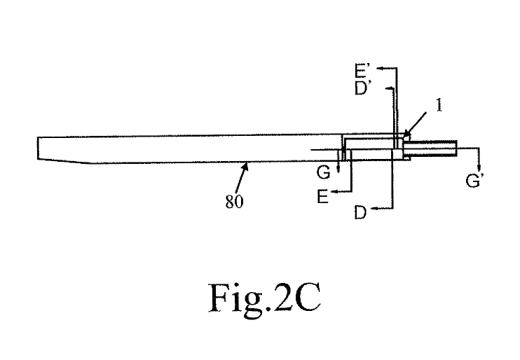

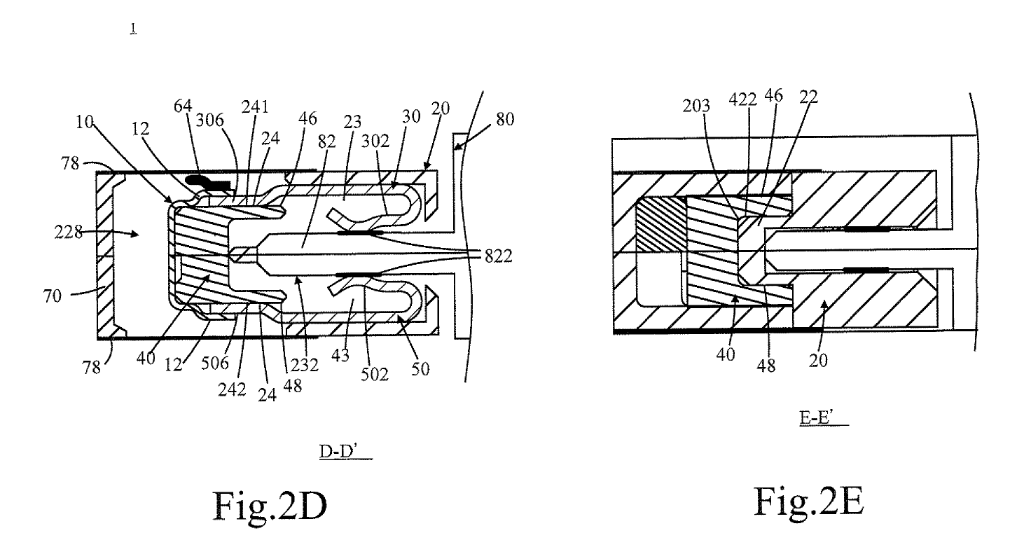

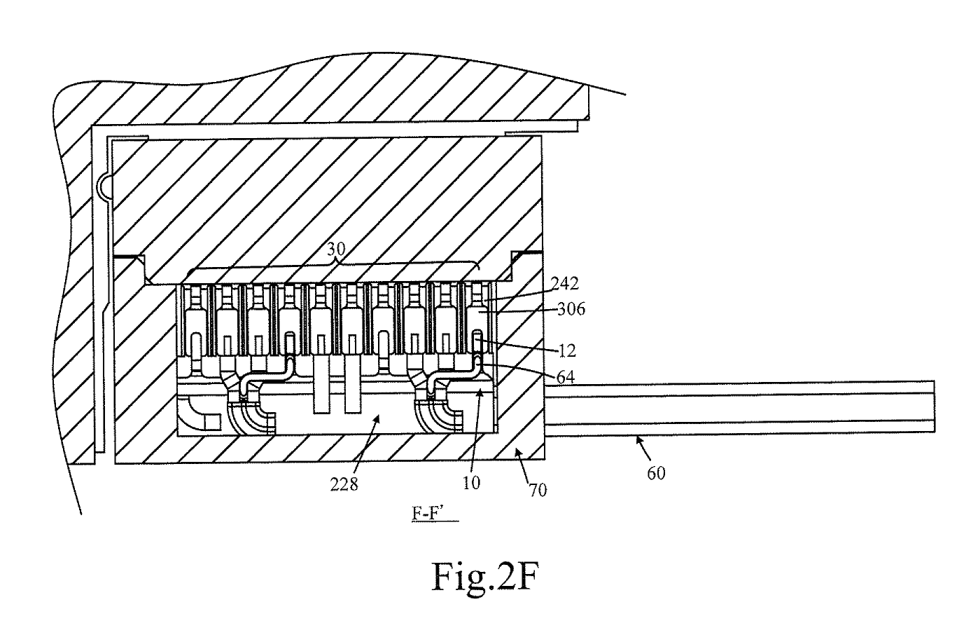

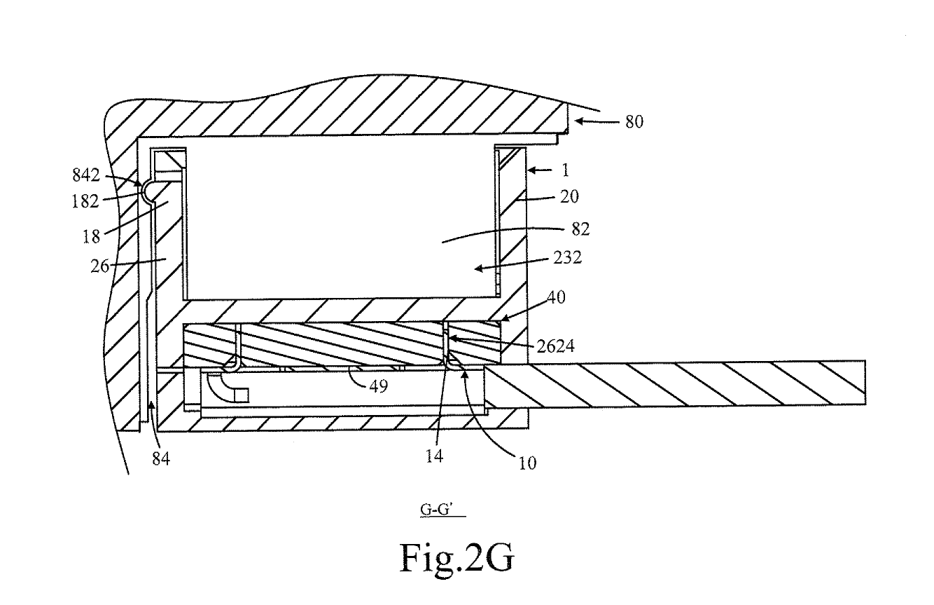

As illustrated in FIGS. 1A and 1B, each terminal of the first row of terminals and second row of terminals 30, 50 has an elastic contact section 302, 502, a plurality of retaining sections 304, 504 and a soldering section 306, 506. The elastic contact section 302, 502 include a plurality of consecutive bending sections (See FIG. 2D). The retaining sections 304, 504 such as barbs or bumps, are connected to the elastic contact section 302, 502 and are formed on two sides of the terminals 30, 50 to be held to two opposed side walls of each passage of the corresponding first row and second row of passages 23, 43 of the first insulated body 20. In other words, the retaining sections 304, 504 are provided to ensure each of the first row of terminals and the second row of terminals 30, 50 respectively and firmly accommodated in the corresponding first row of passages and second row of passages 23, 43. The soldering section 306, 506 is provided for soldering to the corresponding wires contained in the cable 60.

As illustrated in FIGS. 1A and 1B, the second insulated body 40 is disposed at the second end 203 of the first insulated body 20, and is formed with two opposed top and bottom side walls 46, 48 and a central joint wall 49 formed between the top and bottom side walls 46, 48. A second depression 422 is defined jointly by the top and bottom side walls 46, 48 in combination with the joint wall 49, and a position of the second depression 422 corresponds to the flat portion 22 of the first insulated body 20. An outside wall of each of the side walls 46, 48 is an extending surface 24, and two opposed ends of an inside wall of each of the side walls 46, 48 are respectively formed with a first protrusive section 462 extending toward the second depression 422, wherein a first row of guiding grooves 241 and a second row of guiding grooves 242 are respectively formed on the extending surfaces 24 of the top and bottom side walls 46, 48, and two recesses 2624 are formed on the joint wall 49. It should be noted that, as the first embodiment illustrated in FIGS. 1A and 1B, each of the first notch sections 262 of the first insulated body 20 is complementary in structure to each of the first protrusive section 462 of the second insulated body 20, whereby the each of the first notch sections 262 can engage with a corresponding first protrusive section 462 to form each engaging unit 2648, and therefore a plurality of first engaging units 2648 are formed jointly between the first and the second insulated bodies 20, 40. However, in other embodiments, an engaging unit (not shown) is only disposed on the side wall of either of the first and second insulated body 20, 40 or therebetween. Also, in other embodiments, the left and right side walls 26, 28 of the first insulated body 20 are altered to dispose two protrusive sections (not shown) corresponding to two first dents (not shown) of the top and bottom side walls 46, 48 of the second insulated body 40. Additionally, in other embodiments, the left and right side walls 26, 28 of the first insulated body 20 are altered to dispose a first notch section and a first protrusive section (not shown) corresponding to the first protrusive section and a first notch section (not shown) of the top and bottom side walls 46, 48 of the second insulated body 40. Any replacement or change regarding the protrusive section and the notch section should be deemed as falling into the conception of the present invention.

As illustrated in FIGS. 1A and 1B, the conductive shell 10 is formed by a longitudinal metal plate, and a plurality of grounding fingers 12 are flexible and formed at the edges of the top and bottom surfaces of the plate, so as to be disposed, corresponding to the soldering sections 306, 506 of the plurality of the predetermined terminals 30, 50. Furthermore, each of the grounding fingers extends respectively toward the extending surface 24 of the top and bottom side walls 46, 48 of the second insulated body 20 corresponding to the first row of guiding grooves 241 and the second row of guiding grooves 242. Besides, the plate is punched to form two barbed securing portions 14 extending correspondingly to the two recesses 2624 of the joint wall 49 of the second insulated body 40 and thereby being fixed on relative sidewalls of the corresponding recess 2624 for retaining the conductive shell 10 onto the second insulated body 40.

As illustrated in FIGS. 1A and 1B, a cover 70 has a plurality of side walls formed respectively on the four corners of the cover 70. A second protrusive section 482 is formed on the side wall of each of the corners. A position of each of the second protrusive section 482 corresponds to a position of the second notch section 282 of the first insulated body 20, and an opening 284 is defined by the side walls of the cover 70. Since each of the second protrusive sections 482 of the cover 70 and the corresponding one of the second notch sections of the first insulated body 20 are complementary structurally to each other, such that each of the second notch sections 282 can be engaged to the corresponding second protrusive section 482 to form a second engaging unit 2846 as illustrated in FIG. 1D, and therefore a plurality of second engaging units 2846 can be formed between the first insulated body 20 and the cover 70.

As illustrated in FIG. 1A and 1B, when each of the first row of corresponding terminals 30 and the second row of corresponding terminals 50 is respectively attached to the first row of passages 23 and the second row of passages 43 of the first insulated body 20, the assembling of the two rows of terminals 30, 50 can be simultaneous or one by one (the assembling result is illustrated as in FIG. 2D.). Namely, each of the flexible contacting sections 302, 502 of each of the row of terminals 30, 50 extends into the central slot 232. The retaining sections 304, 504 are all fixed to the corresponding passages 23, 43, and the soldering sections 306, 506 all extend beyond the corresponding passages 23, 43 and are exposed outward the top and bottom surfaces of the flat portion 22, respectively.

As illustrated in FIGS. 1A and 1B, when the second insulated body 40 is attached to the first insulated body 20, by the first notch section 262 and the first protrusive section 462 contained in the first engaging unit 2648 engaging with each other, the top and bottom side walls 46, 48 of the second insulated body 40 are engaged to the top and bottom surfaces of the flat portion 22 of the first insulated body 20, such that the joint wall 49 of the second insulated body 40 is accommodated in the first depression 222 of the first insulated body 20 (as illustrated in FIG. 1C), wherein the second depression 422 of the second insulated body 40 can accommodate the second end 203 of the first insulated body 20 (as illustrated in FIG. 2E), whereby each of the top and bottom side walls 46, 48 is overlaid on corresponding one of the top and bottom surfaces of the flat portion 22 of the first insulated body 20. Next, the soldering sections 306, 506 exposed outward respective ends of the corresponding passages 23, 43 backwardly enter the corresponding guiding grooves 241, 242 on the extending surfaces 24 of the top and bottom side walls 46, 48 of the second insulated body 40, and the extending surface 24 of each of the top and bottom side walls 46, 48 of the second insulated body 40 holds the soldering sections 206, 506 of the corresponding terminals 30, 50 (as illustrated in FIG. 20). Thereby an operator can perform soldering conveniently in the soldering sections 306, 506 of the terminals 30, 50 and the wires of the cable 60, and the soldering sections 306, 506 will not be shifted by the presses resulted from soldering, thereby the assembly of the cable connector 1 can be quickened. At the same time, each of the soldering sections 306, 506 of the terminals 30, 50 is separated and fixed by a plurality of protrusive bars 2411 formed within each of the guiding grooves 241, 242 as illustrated in FIG. 1A and 1B. Thus, this will bring a convenient soldering, an easy repair and a better product yield, and avoid a possible shorting circuit.

As illustrated in FIG. 1B and 1C, when the conductive shell 10 is further attached to the jointed first and second insulated bodies 20, 40, each of the two securing portions 14 of the conductive shell 10 is inserted into the corresponding one of the two recesses 2624 of the joint wall 49 of the second insulated body 40 to combine the conductive shell 10 onto the joint wall 49 of the second insulated body 40. Thereby, the second insulated body 40 is disposed between the first insulated body 20 and the conductive shell 10 (as illustrated in FIG. 2G). At the same time, each of the a plurality of grounding fingers 12 of the conductive shell 10 extends into each of the guiding grooves 241, 242 of the second insulated body 40 and thereby is electrically connected to the soldering section 306, 506 of a specific part of the terminals 30, 50 in the first row of passages 23 and the second row of passages 43. The plurality of specific terminals 30, 50 are a part of the actual grounding terminals which are electrically connected to the corresponding grounding wire 64 contained in the cable 60 via soldering therebetween so as to establish a shielding protection for the cable connector 1 to prevent an external signal interferences such as ESD or EMI. As illustrated in FIG. 2D and 2F, the plurality of grounding fingers 12 on the top surface of the conductive shell 10 are electrically connected to the soldering section 306 of the specific terminals 30 through the corresponding guiding groove 241, 242, and the soldering section 306 is electrically connected to the corresponding grounding wires 64 of the cable 60 through the soldering therebetween.

As illustrated in FIGS. 1C and 1D, when the cover 70 is further attached to the jointed structure including the first insulated body 20, the second insulated body 40 and the conductive shell 10, by the second notch section 282 and the second protrusive section 482 included in the plurality of second engaging units 2846 engaging with each other, each of the side wall of the cover 70 is engaged to the corresponding one of the top and bottom surfaces of the side walls 26, 28 of the first insulated body 20. At the same time, by combining the opening 284 of the cover 70 with the side wall 28 of the first insulated body 20, a through hole 4642 is further defined jointly for the corresponding cable 60 passing through (as illustrated in FIG. 1D). By the above combination, as illustrated in FIGS. 2D and 2F, an accommodating space 228 is defined jointly by the cover 70 in combination with the conductive shell 10 so as to provide a space needed between the soldering sections 306, 506 of the rows of terminals 30, 50 and the corresponding cable 60 for soldering therebetween.

In the present embodiment, as illustrated in FIG. 1D, each of the pair of patches 78 is disposed on the corresponding one of the top and bottom surfaces of the assembled structure including the first insulated body 20, the second insulated body and the cover 70, and as illustrated in FIG. 2D, is provided for covering the accommodating space 228 to further isolate the grounding wire 64 and the terminals 30, 50 located in the accommodating space 228 from the outside environment, whereby the assembling of the whole cable connector 1 is completed. In the present embodiment, the patch 78 is an adhesive and flexible patch, such as a Mylar patch. However, in other embodiments, the patch 78 can be made of plastic or metal in one piece.

Please refer to FIGS. 2A and 2B, which illustrate an electronic device 80 for being inserted into the cable connector 1 to be electrically connected with the cable connector 1. In the present embodiment, the electronic device 80 can be a storage device such as a hard disk, and a notch is formed on a lower right corner of the electronic device 80 to expose a circuit board 82 extending outward, a row of conductive contact pad 822 are formed on the top and bottom surface of the circuit board, and a gap 84 is formed between one a side edge of the circuit board 82 and the side wall of the notch. Please further refer to FIG. 20, in the gap 84, a bay 842 is formed in the side wall of the opening of the electronic device 80. When the circuit board 82 of the electronic device 80 is inserted into the central slot 232 of the cable connector 1, the left side wall 26 of the cable connector 1 is also extended into the gap 84 at the circuit board 82, so that the clamping portion 182 of the spring latching arm 18 is engaged with the bay 842 in the gap 84 to secure the electrical connection between the cable connector 1 and the electronic device 80 and avoid being detached.

Please further refer to FIGS. 2C and 2D, when the circuit board 82 of the electronic device 80 is inserted into the central slot 232 of the cable connector 1, each of the contact pads 822 of the top and bottom surfaces of the circuit board 82 elastically presses and contacts a front-end bending section in each of the elastic contact sections 302, 502 of the top and bottom rows of terminals 30, 50 extended into the central slot 232, besides enabling electrical connection between the contact pads 822 and the terminals 30, 50; at the same time, each of the contact pad 822 applies a counterforce relative to the spring force on each of the front-end bending sections of the elastic contact sections 302, 502 to shift each of the elastic contact sections 302, 502 backward slightly.

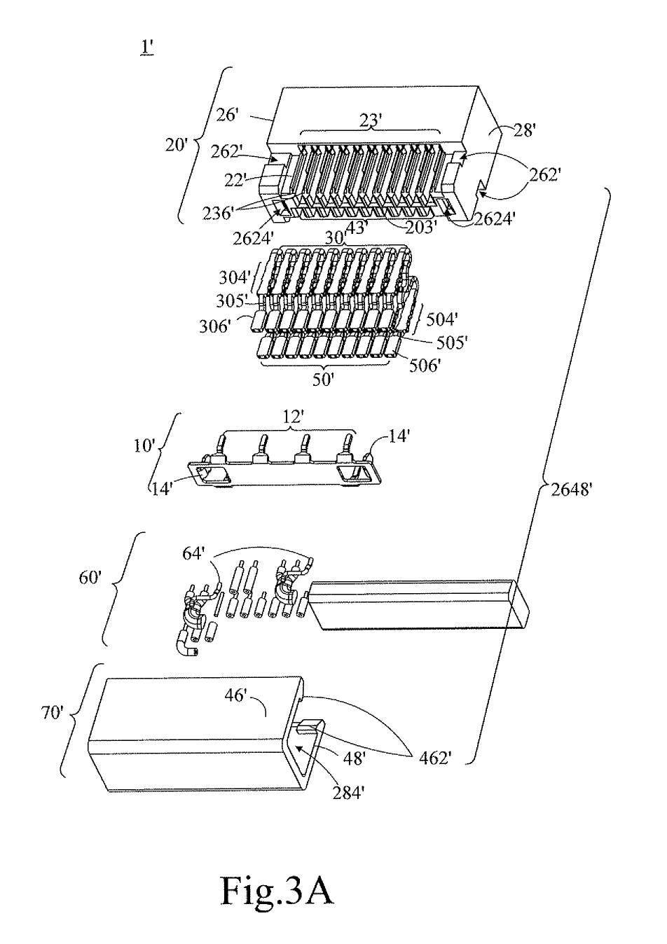

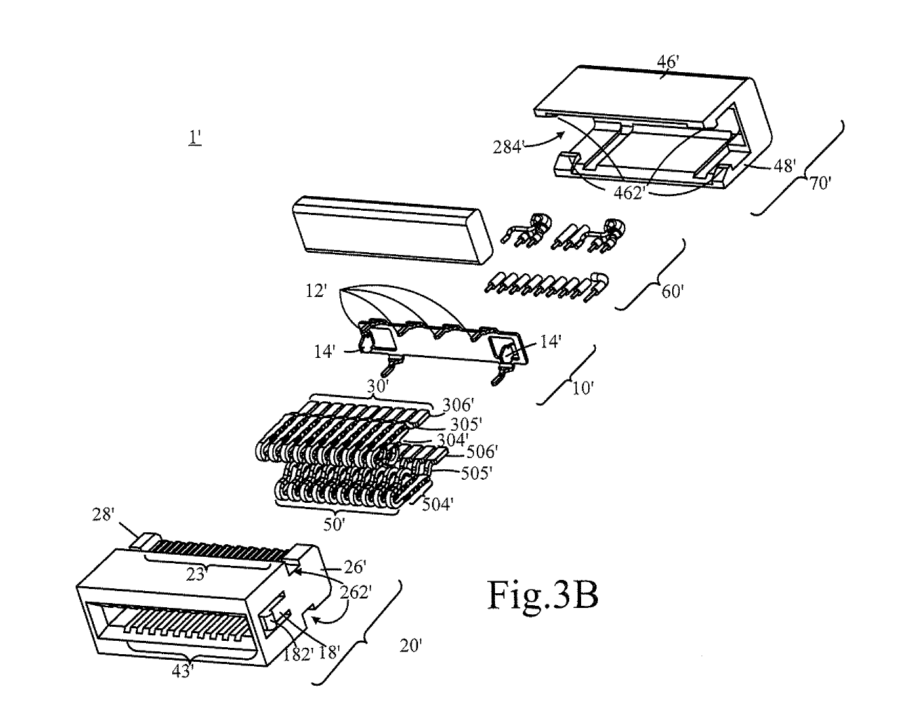

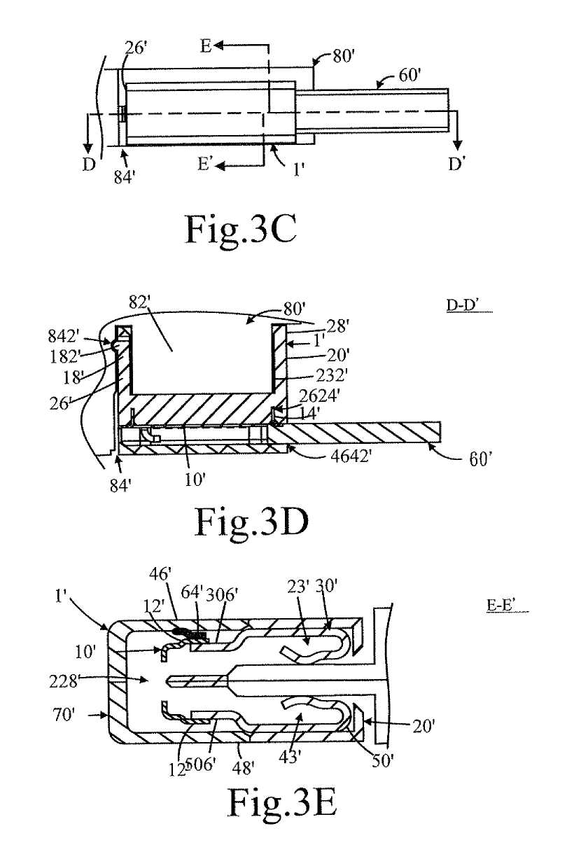

Also, please refer to FIGS. 3A and 3B, FIGS. 3A and 3B illustrate a cable connector 1′ in a second preferred embodiment according to the present invention, the cable connector 1′ comprises a conductive shell 10′, an insulated body 20′, a first row of terminals 30′, a second row of terminals 50′, a cable 60′ containing a bunch of wires, and a cover 70′. The cable connector 1′ in the second preferred embodiment according to the present invention is distinguished from the cable connector 1 in the first embodiment by: the cable connector 1′ in the second preferred embodiment illustrated by FIGS. 3A and 3B has no components of second insulated body 40, the first depression 222 and the patch 78 as the cable connector 1 illustrated in FIG. 1A has, thus the two securing portions 14′ of the conductive shell 10′ in the cable connector 1′ are directly engaged into the two recesses 2624′ formed on the rear-ends of the left and right side walls 26, 28′ of the insulated body 20′ (as illustrated in FIG. 3D), in the meanwhile, an undulating connecting sections 305′, 505′ is formed between at least one retaining section 304′, 504′ of each of the terminals 30′ 50′ and the soldering sections 306′, 506′, so that each of the two sides of the soldering sections 306′, 506′ presses each of the slot walls of the two cornered slots 236′ formed on both sidewalls of the corresponding passages 23′, 43′, the two opposed cornered slots 236′ are provided to support the soldering sections 306′, 506′ of the corresponding terminals 30′, 50′ upwardly to prevent the soldering sections 306′, 506′ from being shifted while being soldered. Besides, as illustrated in FIGS. 3A and 3B, the cover 70′ of the cable connector is provided with two top and bottom corresponding side walls 46′, 48′. Protrusive sections 462′ are formed on the two ends of the internal surfaces of each of the side walls 46′, 48. Each of the protrusive sections 462′ is positioned corresponding to each of the notch sections 262′ formed in the top and bottom surfaces of the left and right side walls 26′, 28′ of the insulated body 20′. Each pair of protrusive section 462′ and notch section 262′ is complementary structurally to form an engaging unit 2648′.

Please further refer to FIGS. 3A and 3E, when the insulated body 20′, the conductive shell 10′ and the cover 70′ are attached to the cable connector 1′, an accommodating space 228′ is defined between the cover 70′ and the conductive shell 10′ for the electrical connection between the soldering sections 306′, 506′ of the rows of terminals 30′, 50′ and a corresponding cable 60′, wherein the side walls 46′, 48′ of the cover 70′ are engaged to the corresponding side walls 26′, 28′ of the insulated body 20′ via the engaging units 2648′ to dispose the conductive shell 10′ between the insulated body 20′ and the cover 70′, so that a through hole 4642′ for the corresponding cable 60′ passing through is defined jointly by the opening 284′ on one side of the cover 70′ in combination with a side wall 28′ of the insulated body 20′ (as illustrated in FIG. 3D).

In the meanwhile, as illustrated in FIGS. 3A and 3E, each of the grounding fingers 12′ of the conductive shell 10′ is extended into each of the corresponding slots 23′, 43′ in the top and bottom surfaces of the flat portion 22′ from the second end 203′ of the flat portion 22′ of the insulated body 20′, and thereby is electrically connected to a surface of the soldering section 306′, 506′ of specific terminal 30′, 50′ in the rows of passages 23′, 43′, wherein the specific terminals 30′, 50′ as actual grounding terminals are electrically connected to the corresponding grounding wires 64′ included in the cable 60′ through soldering to establish a shielding protection for the cable connector 1′ to prevent external signal interferences such as ESD or EMI.

Please further refer to FIGS. 3C and 3D, when the circuit board 82′ of the electronic device 80′ is inserted into the central slot 232′ of the cable connector 1′, the left side wall 26′ of the cable connector 1′ also extends into the gap 84′ at the circuit board 82′, so that the clamping portion 182′ (see FIG. 3D) of the spring latching arm 18′ is engaged to the bay 842′ in the gap 84′ to secure the electrical connection between the cable connector 1′ and the electronic device 80′ and avoid being detached. Besides, other components and operations in the second preferred embodiment that are similar to the first embodiment according to the present invention are not discussed.

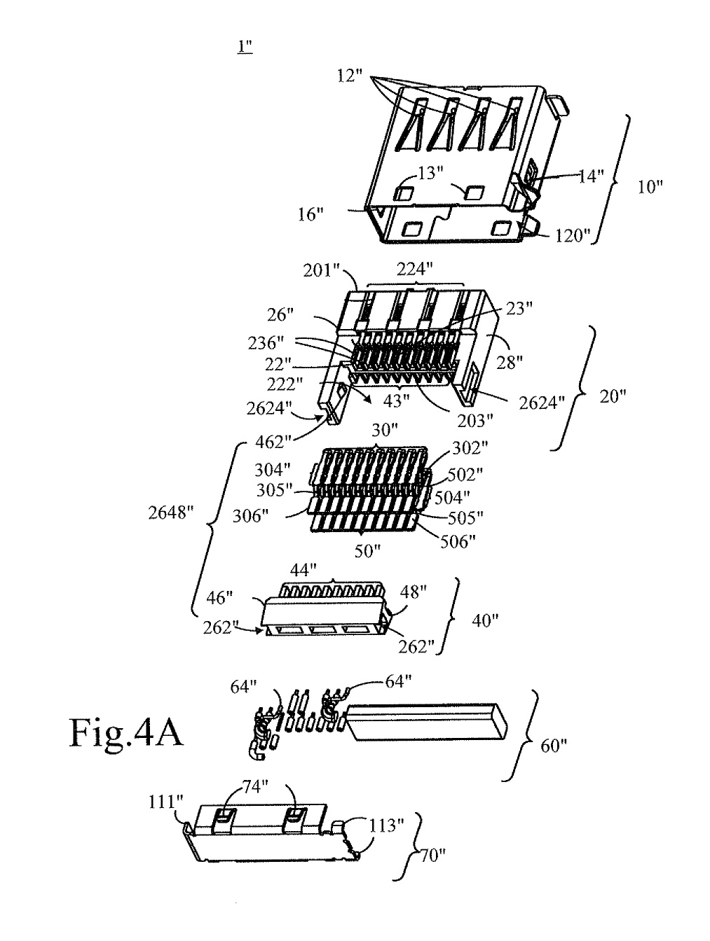

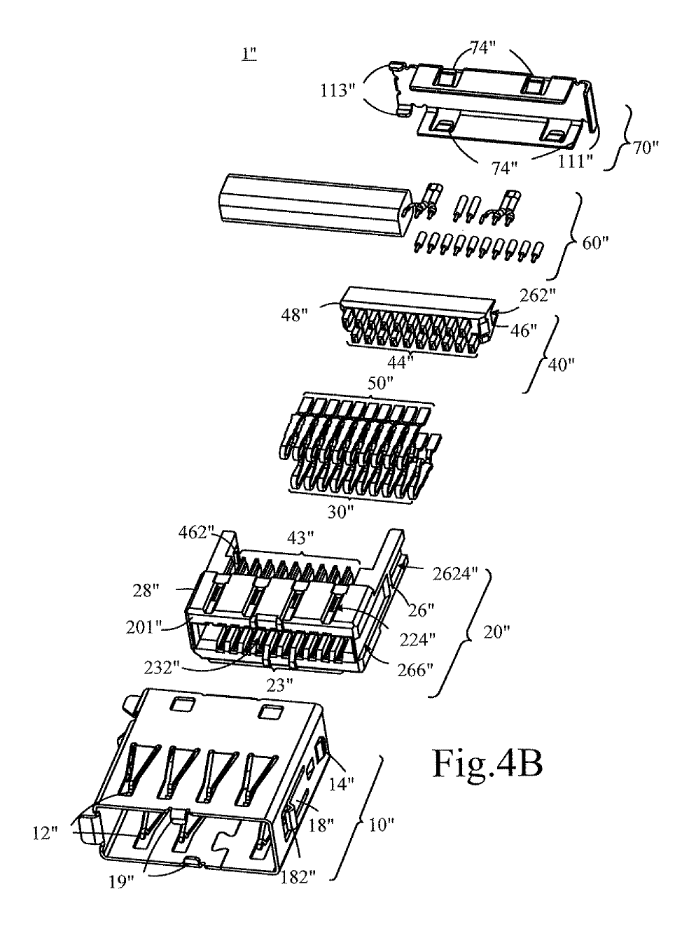

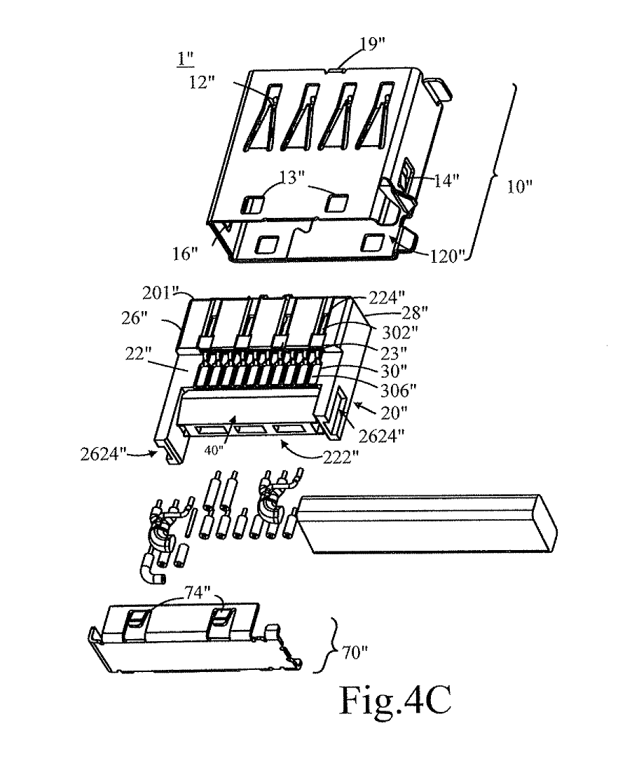

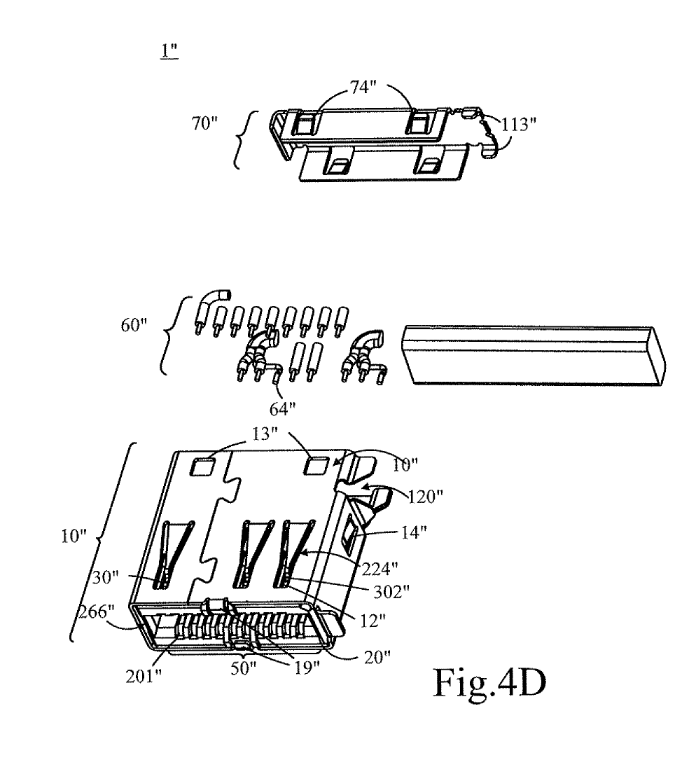

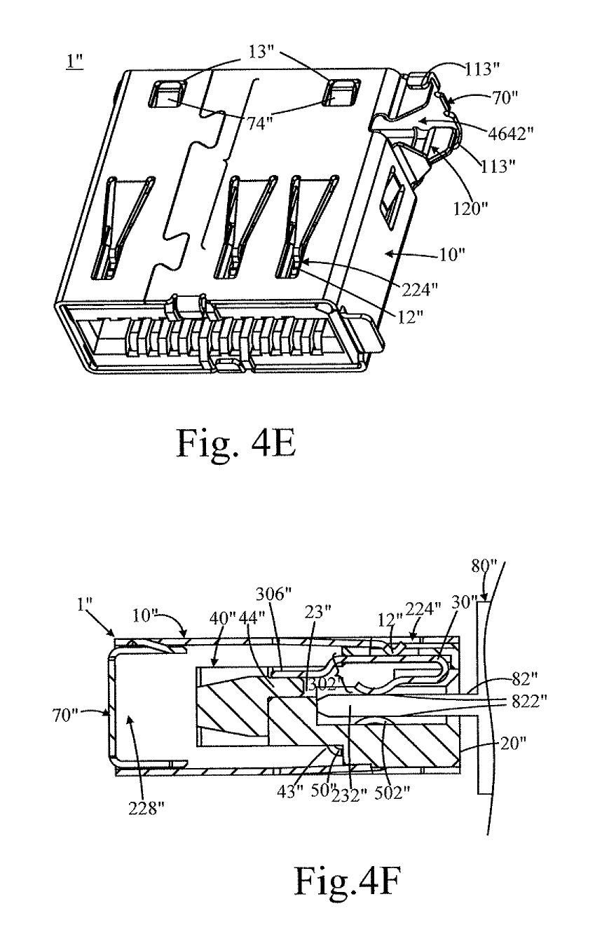

Please refer to FIGS. 4A and 4B, FIGS. 4A and 4B illustrate a cable connector 1″ in a third embodiment according to the present invention, which comprises a conductive shell 10″, two detachable insulated bodies as a first insulated body 20″ and a second insulated body 40″, a first row of terminals 30″, a second row of terminals 55″, a cable 60″ containing a bunch of wires, and a cover 70″.

As illustrated in FIGS. 4A and 4B, the conductive shell 10″ is provided to electrically shield the cable connector 1″, which comprises four side walls, and a hollowing space is defined within the four side walls to accommodate the insulated bodies 20″, 40″. An inward denting securing portion 14″ and an opening 120″ are formed in the right side wall of the four side walls, and the opening 120″ is provided for the cable 60″ passing through. An inward denting securing portion 16″ and an outward bending and extending spring latching arm 18″ are formed in the left side wall, and an outward clamping portion 182″ is formed on the end of the spring latching arm 18″. A row of inward bending spring grounding fingers 12″ are formed on each of the two top and bottom side walls of the four side walls. A securing portion 19″ and two holes 13″ are formed in the top and bottom side walls of the four side walls of the conductive shell 1″.

As illustrated in FIGS. 4A and 4B, a flat portion 22″ extending horizontally is formed on the first insulated body 20″, and the flat portion 22″ comprises a first end 201″, a second end 203″ corresponding to the first end 201″, a central slot 232″extending to formed the first end 201″ of the flat portion 22″ towards the inside of the first insulated body 20″, and a first row of passages 23″ and a second row of passages 43″ formed between the first end 201″ and the second end 203″. Each of the first row of passages 23″ and second row passages 43″ extends horizontally to the two top and bottom surface of the flat portion 22″ from the two opposed walls in the central slot 232″ to correspondingly accommodate the plurality of rows of terminals 30″, 50″, wherein two opposed cornered slots 236″ are formed adjacent both sidewalls of each of the passages 23″, 43″ on the second end 203″ of the flat portion. Besides, two rows of apertures 224″ are respectively formed in the top and bottom outside walls of the flat portion 22″ in the first insulated body 20″, and each of the two rows of apertures 224″ perpendicularly passes through each of the top and bottom outside walls of the first insulated body 20″, so as to be further connected to the corresponding passages 23″ in the first row of passages 23″ and the corresponding passages 43″ in the second row of passages 43″.

As illustrated in FIGS. 4A and 4B a depression 222″ is defined jointly by the left and right side walls 26″, 28″ in combination with the flat portion 22″. Two recesses 2624″ are formed in the outside surfaces of the left and right two side walls 26″, 28″ corresponding to the securing portions 14″, 16″ of the conductive shell 10″. A denting part 266″ corresponds to the spring latching arm 18″ of the conductive shell 10″, and two opposed protrusive sections 462″ are formed inside the surfaces of the side walls 26″, 28″, which are extended towards the depression 222″.

As illustrated in FIGS. 4A and 48, each terminal 30″, 50″ of the first row of terminals and second row of terminals 30″, 50″ has an elastic contact section 302″, 502″ , a plurality of retaining sections 304″, 504″ and a soldering section 306″, 506″, wherein the elastic contact section 302″, 502″ includes a plurality of consecutive bending sections (see FIG. 4F), the retaining sections 304″, 504″, such as barbs or bumps, are connected to the elastic contact sections 302″, 502″ and are disposed on the two sides of the terminals 30″, 50″. The soldering sections 306″, 506″ are provided to be soldered to the cable included in the cable 60″. In the meanwhile, an undulating connecting sections 305″, 505″ is formed between at least one retaining section 304″, 504″ of each of the terminals 30″ 50″ and the soldering sections 306″, 506″, so that each of two sides of the soldering section 306″, 506″presses each of the slot walls of the two cornered slots 236″ formed on both sidewalls of the corresponding passage 23″, 43″, so that the two opposed cornered slots 236″ are holding the soldering section 306″, 506″ of the corresponding terminal 30″, 50″ to prevent the soldering section 306″, 506″ from being shifted while being soldered.

As illustrated in FIGS. 4A and 4B, the second insulated body 40″ is accommodated in the depression 222″ of the first insulated body 20″. The second insulated body 40″ has two left and right side walls 46″, 48″, and two opposed denting sections 262″ are formed on each of the outside surface of the left and right side walls 46″, 48″ in corresponding to the two protrusive sections 462″ of the first insulated body 20″, and each pair of the protrusive section 462″ and the denting section 262″ are complementary structurally to form an engaging unit 2648″. It should be noted that in other embodiments, an engaging unit (not shown) can be disposed on the side wall of either one of the first and second insulated body 20″, 40″ or therebetween. In other embodiments, the left and right side wall 26″, 28″ of the first insulated body 20″ is altered to dispose a denting section and a protrusive section (not shown), corresponding to a protrusive section and a denting section (not shown) respectively disposed on the left and right side walls 46″, 48″ of the second insulated body 40″. In other embodiments, the left and right side walls 26″, 28″ of the first insulated body 20″ is altered to dispose two denting sections (not shown) corresponding to two protrusive sections (not shown) respectively disposed on the left and right side walls 46″, 48″ of the second insulated body 40″. Additionally, as illustrated in FIGS. 4A and 4B, a plurality of supporting bumps 44″ extending horizontally are formed on a front of the second insulated body 40″ corresponding to the second end 203″ of the flat portion 22′ of the first insulated body 20″.

As illustrated in FIGS. 4A and 4B, the cover 70″ is made of a conductive metal piece and the periphery of the conductive metal piece is bent to form a plurality of side walls, wherein two top and bottom side walls forms a plurality of spring fold fins 74″ corresponding to the holes 13″ of the conductive shell 10″, and a perpendicular stopping piece 111″ is formed on the left surface of the cover 70″, and two guiding pieces 113″ are formed on two top and bottom edges on the right surface of the cover 70″.

As illustrated in FIGS. 4A and 4C, when each of the first row of the corresponding terminals 30″ and the second row of corresponding terminals 50″ is respectively attached to the first row of passages 23″ and the second row of passages 43″ of the first insulated body 20″, the assembling of the two rows of terminals 30″, 50″ can be simultaneous or one by one, wherein each of the elastic contact sections 302″, 502″ of each of the row of terminals 30″, 50″ extends into the central slot 232″ (as illustrated in FIG. 4F). The retaining sections 304″, 504″ are all fixed into the corresponding passages 23″, 43″, and the soldering sections 306″, 506″ all extend beyond the corresponding passages 23″, 43″ and are exposed at the top and bottom surfaces of the flat portion 22″. It should be noted that the back surfaces of the elastic contact sections 302″, 502″ of several specific terminals 30″, 50″ are opposite to each other and exposed outward the plurality of apertures 224″.

As illustrated in FIGS. 4A and 4C, when the second insulated body 40″ is further attached to the first insulated body 20″, by a plurality of notch sections 262″ and the protrusive sections 462″ contained in the plurality of engaging units 2648″ engaging with each other, the top and bottom side walls 46″, 48″ of the second insulated body 40″ are engaged to the top and bottom surfaces of the flat portion 22″ of the first insulated body 20″, and each of the supporting bumps 44″ is inserted into the corresponding passages 23″, 43″ of the flat portion 22″ of the first insulated body 20″, so that the second insulated body 40″ is accommodated in the first depression 222″ of the first insulated body 20″ (as illustrated in FIG. 4C), and the terminals 30″, 50″ are positioned between the second insulated body 40″ and the first insulated body 20″. For example as illustrated in FIG. 4F, the supporting bump 44″ is inserted into the corresponding passage 23″ of the first insulated body 20″ to support the soldering section 306″ of the corresponding terminal 30″ accommodated in the corresponding passage 23″, thereby improving the pressure bearing of the soldering sections 306″, which will not be shifted by a pressure resulted from soldering.

As illustrated in FIGS. 4A and 4C, when the conductive shell 10″ is attached to the assembled first and second insulated bodies 20″, 40″, the two securing portions 14″, 16″ of the conductive shell 10″ are engaged to the two recesses 2624″ of the left and right side walls 26″, 28″ of the first insulated body 20″, and the securing portion 19″ of the conductive shell 10″ is engaged to the first end 201″ of the first insulated body 20″ (as illustrated in FIG. 4D) to firmly fix the conductive shell 10″ to the assembled first and second insulated bodies 20″, 40″.

Meanwhile, as illustrated in FIGS. 4B and 4D, the denting part 266″ of the first insulated body 20″ is provided to accommodate the spring latching arm 18″; particularly when the clamping portion 182″ of the spring latching arm 18″ is engaged to a corresponding bay 842 of an electronic device 80 (please refer to FIG. 2G), as engaged and pressed, the spring latching arm 18″ is forcedly and elastically bent towards the inside of the denting part 266″.

As illustrated in FIGS. 4E and 4F, each of the plurality of grounding fingers 12″ on the top and bottom surfaces of the conductive shell 10″ is extended into each of the corresponding apertures 224″ in the top and bottom external surfaces of the first insulated body 20″. For example as illustrated in FIG. 4F, the grounding fingers 12″ on the top surface of the conductive shell 10″ elastically contact with the back surfaces of the elastic contact sections 302″ of the plurality of specific terminals 30″ in the first insulated body 20″ after extended into the apertures 224″, and the specific terminals 30″ as actual grounding terminals are soldered to be electrically connected with the corresponding grounding wires 64″ contained in the cable 60″ (see FIG. 4A), thereby establishing a shielding protection for the cable connector 1″ to prevent an external signal interferences such as ESD or EMI. The same applies to the grounding fingers 12″ on the bottom surface of the conductive shell 10″ to be electrically connected with the back surfaces of each of the elastic contact sections 502″ of specific terminals 50″.

As illustrated in FIGS. 4D and 4E, when the cover 70″ is further attached to the jointed first insulated body 20″, second insulated body 40″ and the conductive shell 10″, the plurality of fold fins 74″ on the top and bottom side walls of the cover 70″ are engaged to the corresponding holes 13″ of the conductive shell 10″, so that an accommodating space 228″ is defined jointly by the cover 70″ in combination with the conductive shell 10″ (as illustrated in FIG. 4F), so as to provide a space needed for the soldering between the rows of terminals 30″, 50″ and the corresponding cable 60″; and next, the two guiding pieces 113″ of the cover 70″ can abut against the top and bottom edges of the opening 120″ in the conductive shell 10″ to define a through hole 4642″ jointly for the corresponding cable 60″ passing through as well as guiding and protecting the corresponding cable 60″, so that the entire assembling of the cable connector 1″ is completed.

Please further refer to a longitudinal cross-sectional view illustrated in FIG. 4F, when a circuit board 82″ of an electronic device 80″ is inserted into a central slot 232″ in the cable connector 1″, each of the contact pads 822″ of the top and bottom surfaces of the circuit board 82″ elastically presses and contacts each of a front-end bending section in the elastic contact sections 302″, 502″ of the top and bottom rows of terminals 30″, 50″ extended into the central slot 232″, besides enabling electrical connection between the contact pads 822″ and the terminals 30″, 50″. At the same time, each of the contact pad 822″ applies a counterforce relative to the spring force on each of the front-end bending sections of the elastic contact sections 302″, 502″ to shift each of the elastic contact sections 302″, 502″ backward slightly, so as to secure the electrical contact between each of the elastic contact sections 302″, 502″ and each of the grounding fingers 12″ of the conductive shell 10″ extended into each of the apertures 224″.

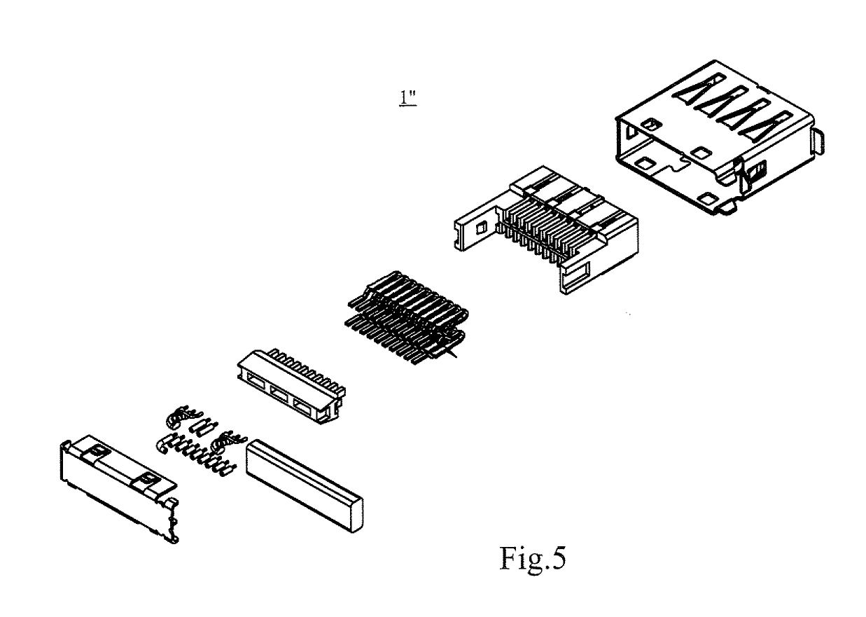

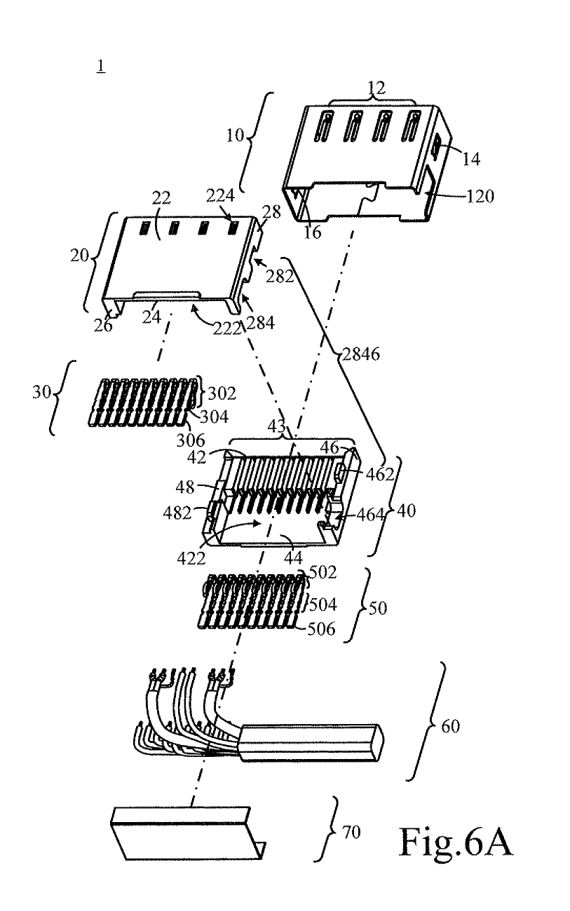

Additionally, please refer to FIG. 5, FIG. 5 illustrate a cable connector 1″ in a forth preferred embodiment, which is only distinguished from the cable connector 1″ in the third embodiment as follows. The cable connector 1″ illustrated in FIG. 5 does not comprises a structure as the cornered slot 236″ of the cable connector 1″ illustrated in FIG. 4A. Besides, other components and operations in the fourth preferred embodiment that are similar to those of the third embodiment according to the present invention are not discussed in here.

In conclusion, based on the above introductions on the engaging unit of the cable connector according to the present invention, the assembling of the components such as the insulated bodies and the cover of the cable connector can be conveniently quickened. When each of the corresponding wires is soldered to the soldering section of each of the terminals, with the support of the cornered slots of the corresponding passage of the at least one insulated body, or the extending surface or supporting bump of the second insulated body, the soldering section is prevented from being shifted while being pressed, so as to improve the handiness and accuracy for the soldering. By electrically connecting at least one grounding finger of the conductive shell to the elastic contact section or soldering section of each specific terminal in the at least one insulated body, via the corresponding grounding wires electrically connecting to the terminals, a preferable shielding protection is established for the cable connector to prevent an external signal interferences such as ESD or EMI.

Additionally, the present invention further provides an electrical apparatus such as a computer, a smart phone, a digital TV, a tablet computer, a digital camera that comprises the cable connector in the above-mentioned embodiments.

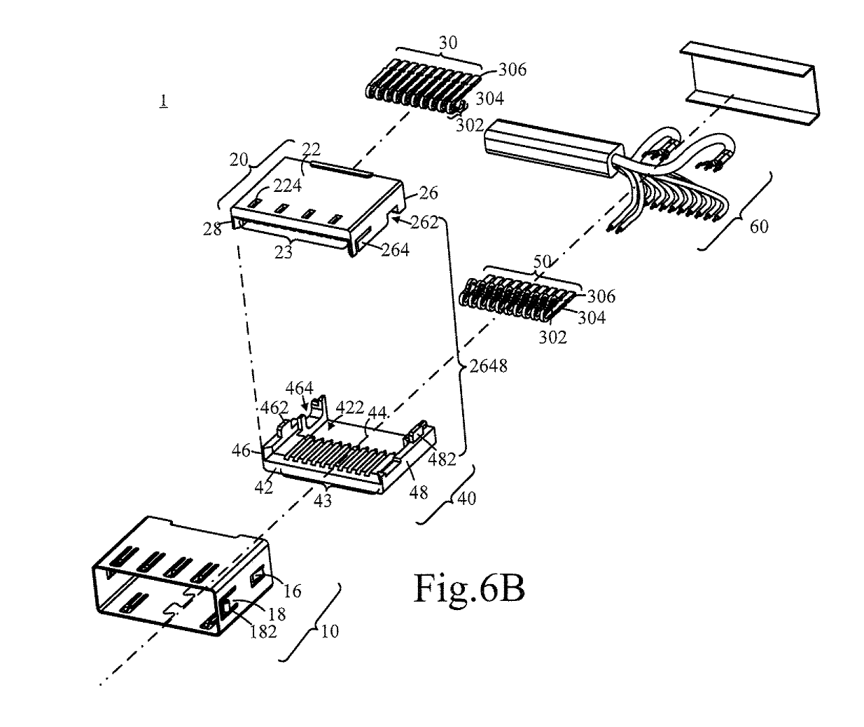

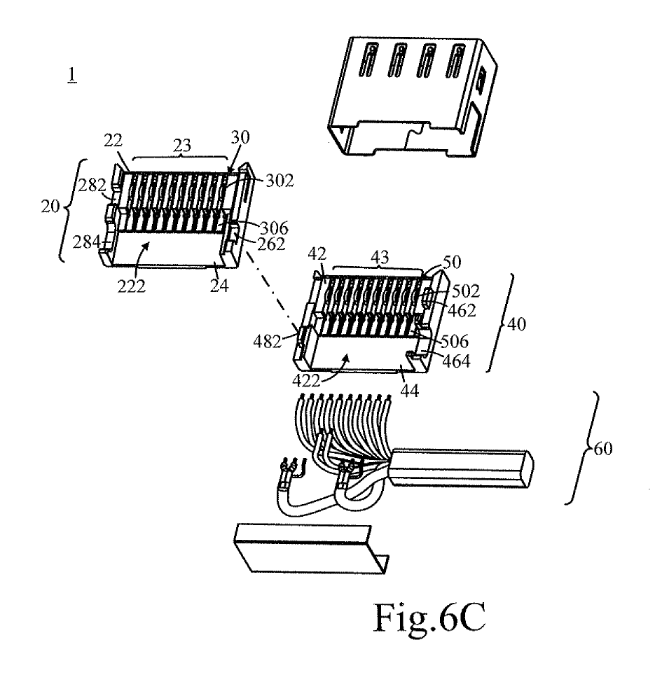

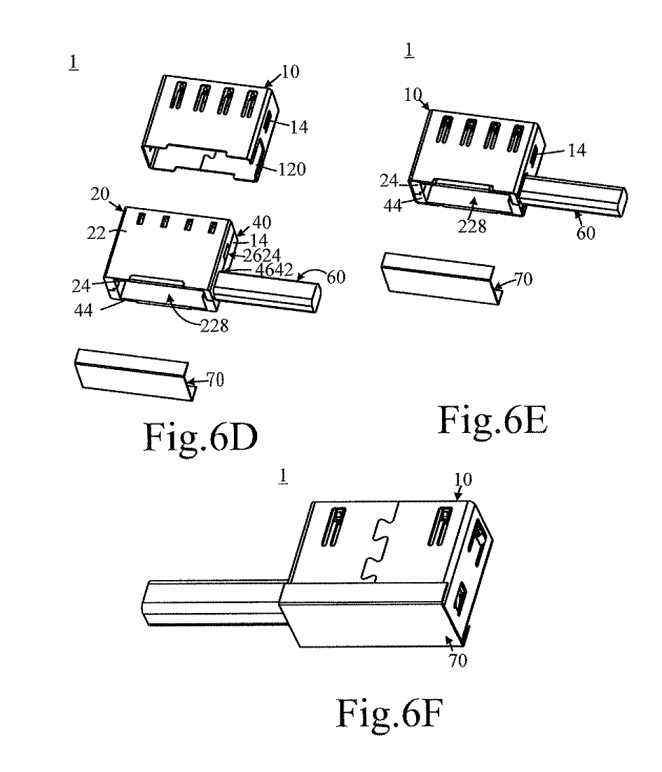

Please refer to FIGS. 6A and 6B, FIGS. 6A and 6B illustrate a cable connector 1 in a fifth preferred embodiment according to the present invention comprises a conductive shell 10, two detachable insulated bodies as a first insulated body 20 and a second insulated body 40, a first row of terminals 30, a second row of terminals 50, a cable 60 containing a bunch of wires, and a cover 70.

Please refer to FIGS. 6A and 6B, FIGS. 6A and 6B illustrate the conductive shell comprises four side walls, and a hollowing space is defined amid the four side walls to accommodate the insulated bodies 20, 40. An inward denting securing portion 14 and an opening 120 are formed in the right side wall of the four side walls, and the opening 120 is provided for the cable 60 passing through. An inward denting securing portion 16 and a spring latching arm 18 are formed in the left side wall, and an outward clamping portion 182 is formed on the end of the spring latching arm 18. A row of inward bending spring grounding fingers 12 are formed on each of the two top and bottom side walls of the four side walls. It should be noted that the extending directions of the two securing portions 14, 16 on the left and right side walls of the conductive shell 10 are opposite to each other.

As illustrated in FIGS. 6A and 6B, the first insulated body 20 has a first flat portion 22, an extending surface 24 and a horizontal first row of passages 23 formed on the first flat portion 22. The extending surface 24 is connected to respective ends of the first row of passages (see FIG. 6C for details), and the first row of passages is provided to accommodate the first row of terminals 30. At least one row of apertures 224 are formed in the first flat portion 22 and are perpendicularly extended to the corresponding ones of the first row of passages 23. The first insulated body 20 has two left and right side walls 26, 28 formed on two sides of the first flat portion 22, respectively, and a first depression 222 is defined jointly by the two side walls 26, 28 in combination with the extending surface 24, as illustrated in FIG. 6A, a notch section 262 and a latching arm support section 264 having a lateral elasticity are formed on a bottom surface of the left side wall 26, the latching arm support section 264 is provided to press and support the spring latching arm 18 of the conductive shell 10.

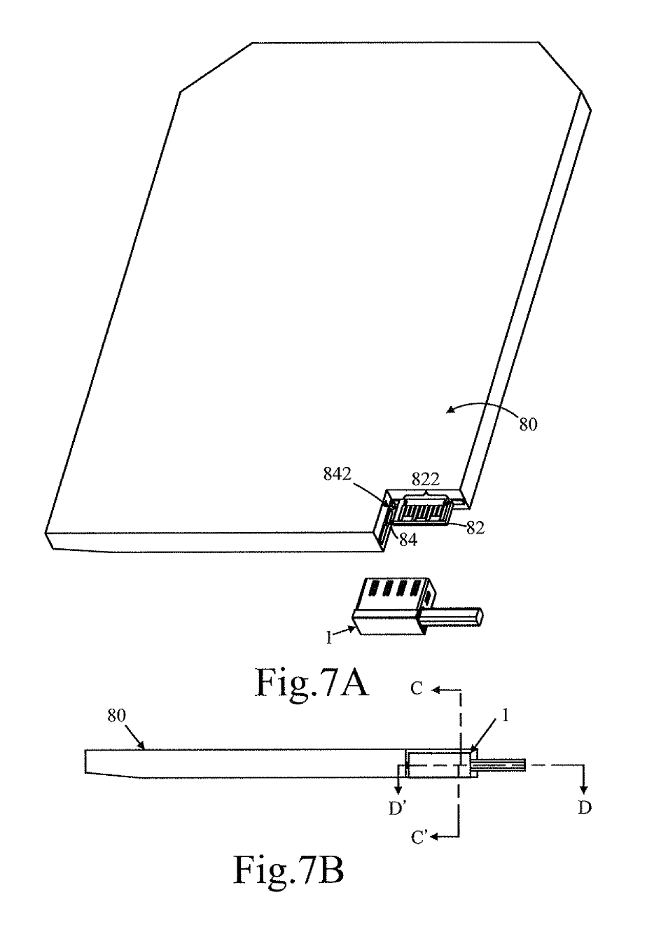

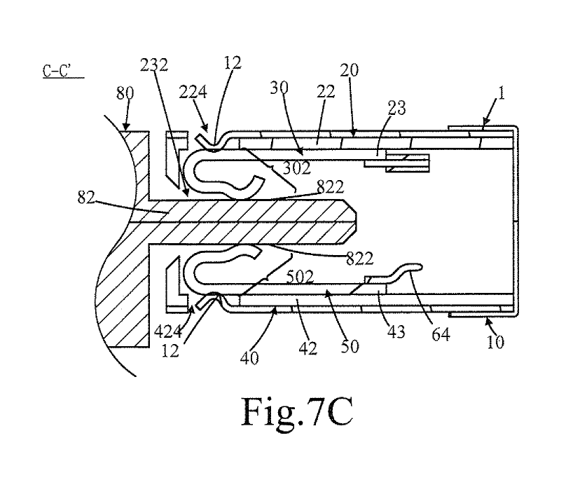

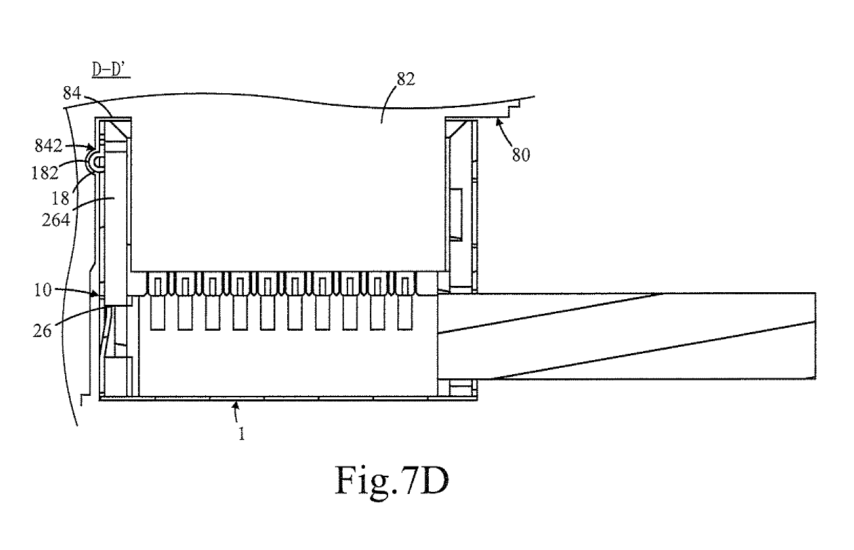

As illustrated in FIGS. 6A and 6B, each terminal of the first row of terminals 30 is provided with an elastic contact section 302, a plurality of retaining sections 304, and a soldering section 306, wherein the elastic contact sections 302 includes a plurality of consecutive bending sections (See FIG. 7C). The retaining section 304 such as a barb or a bump is connected to the elastic contact section 302 and is disposed on two sides of the terminals 30 to contact with the two opposed side walls of the corresponding passage 23 of the first insulated body 20, so as to firmly fix the row of terminals 30 into the corresponding row of passages 23. The soldering section 306 is provided to be soldered to the corresponding wire contained in the cable 60 and to form a coplanar connection with the retaining sections 304.

As illustrated in FIGS. 6A and 6B, the second insulated body 40 has a second flat portion 42, and an extending surface 44 and a horizontal second row of passages 43 formed on the second flat portion 42. The extending surface 44 is connected to respective ends of the second row of passages, and the second row of passages is provided to accommodate the second row of terminals 50. At least one row of apertures 424 are formed on the second flat portion 42, which are perpendicularly extended into the corresponding ones 43 of the second row of passages 43. The second insulated body 40 has two left and right side walls 46, 48 formed on two sides of the second flat portion 42, respectively, and a second depression 422 is defined jointly by the two side walls 46, 48 in combination with the extending surface 44, and the second depression 422 is positioned opposite to the first depression 222 of the first insulated body 20. A protrusive section 462 and an opening 464 are formed on the top surface of the right side wall 46. The protrusive section 462 is positioned corresponding to the notch section 282 of on the right side wall 28 of the first insulated body 20. The thickness of the protrusive section 462 is less than that of the right side wall 46, so that a terrace structure is formed on the joint of the protrusive section 462 and the top surface of the left side wall 46. The opening 464 of the right side wall 46 and the opening 284 in the right side wall 28 of the first insulated body are positioned corresponding to each other. A protrusive section 482 is formed in the top surface of the left side wall 48, which is positioned corresponding to the notch section 262 in the left side wall 26 of the first insulated body 20. The thickness of the protrusive section 482 is less than that of the left side wall 48, so that a terrace structure is formed on the joint of the protrusive section 482 and the top surface of the left side wall 48 (see FIG. 6B).

It should be noted that as the fifth embodiment illustrated in FIGS. 6A and 6B, each of the notch sections 262, 282 of the first insulated body 20 and each of the protrusive sections 482, 462 are complementary structurally to each other, so that each of the notch section 262, 282 is engaged to corresponding one of the corresponding protrusive sections 482, 462 to form each of the engaging units 2648, 2846. Nevertheless, in other embodiments, an engaging unit is only disposed on the side wall of either one of the first insulated bodies 20, 40 or therebetween (not shown). In other embodiments, a notch section and a protrusive section are respectively disposed on the right and left side walls 26, 28 of the first insulated body 20 (not shown), corresponding to the protrusive section and notch section disposed respectively on the left and right side walls 46, 48 of the second insulated body 40 (not shown).

As illustrated in FIGS. 6A and 6B, each terminal of the second row of terminals 50 is provided with an elastic contact section 502, a plurality of retaining sections 504, and a soldering section 506, wherein the elastic contact sections 502 includes a plurality of consecutive bending sections (See FIG. 7C) for enhancing its spring contact. The at least one retaining section 504 such as a barb or a bump is connected to the elastic contact section 502 and is disposed on two sides of the terminals 50 so as to contact with the two opposed side walls of the corresponding passage 43 of the second insulated body 40, thereby firmly fixing the row of terminals 50 into the corresponding row of passages 43. The soldering section 506 is provided to be soldered to the corresponding wire contained in the cable 60 and to form a coplanar connection with the at least one retaining section 504.

As illustrated in FIGS. 6A and 6B, when the first row of corresponding terminals 30 are to be attached to the first row of passages 23 of the first insulated body 20 and the second row of corresponding terminals 50 are to be attached to the second row of passages 43 of the second insulated body 40, the assembling can be simultaneous or one by one, the completed assembling is illustrated in FIG. 6C; in order to be easily understood, the first insulated body 20 illustrated in FIG. 6C is rotated 180° over that in the FIG. 6B, wherein the elastic contact sections 302, 502 of each of the row of terminals 30, 50 extend upwardly beyond the corresponding passages 23, 43, and the retaining sections 304, 504 are all fixed into the corresponding passages 23, 43. The soldering sections 306, 506 are all extended backwardly from the end of the corresponding passages 23, 43 into the extending surfaces 24, 44 and are exposed at the first and second cavities 222, 422 in the extending surfaces 24, 44. Next, utilizing the separated first and second cavities 222, 242 of the first and second insulated bodies 20, 40, the soldering between the soldering sections 306, 506 of different rows of terminals 30, 50 on the first and second insulated bodies 20, 40 and the corresponding cable of the cable 60 is provided can be conducted simultaneously or separately by an operator, so that the assembling and the cable connector 1 can be quickened. In the case a terminal of the terminals 30, 50 is experiencing irreparable problems, only the corresponding first and second insulated bodies 20, 40 are required to be replaced and easily maintained, therefore the yield is improved and the manufacturing cost is down.

Please refer to FIGS. 6C and 6D, FIGS. 6C and 6D illustrate the first and second insulated bodies 20, 40 are stacked perpendicularly, and by engaging the notch sections 262, 282 with protrusive sections 482, 462, as included in the engaging units 2648, 2846 between the first and second insulated bodies 20, 40, the first and second insulated bodies 20, 40 can be assembled. After the notch sections 262, 282 and the protrusive sections 482, 462 of the first and second insulated bodies are engaged to each other, a recess 2624 can be formed on each of the afore-mentioned engaging units 2648, 2846 in combination with the top and bottom terrace structures on the side (as illustrated in FIG. 6D). A through hole 4642 (as illustrated in FIG. 6D) for the cable 60 passing through is defined jointly by joining up and down the two openings 284, 464. Please refer to FIGS. 6C and 6D again, when the assembling of the first and second insulated bodies 20, 40 are completed, the two extending surfaces 22, 24 of the first and second insulated bodies 20, 40 are opposed apart away from each other, so that the first and second cavities 222, 422 in each of the extending surfaces 22, 24 are joint together to define a more spacious accommodating space 228 to accommodate the soldering between the soldering sections 306, 506 of the different rows of terminals 30, 50 and the cable 60. At the same time, as illustrated in FIG. 7C, the first row of passages 23 and second row of passages 43 of the first and second insulated bodies 20, 40 are opposed in an up-and-down alternative arrangement. A central slot 232 is defined between the first row of passages 23 and the second row of passages, so that the each of the elastic contact sections 302, 502 of the first and second rows of terminals 30, 50 are extended into the central slots 232.

Please refer to FIGS. 6D and 6E, when the conductive shell 10 is further disposed to the assembled first and second insulated bodies 20, 40, the two opposite extending securing portions 14, 16 (see FIG. 6B) of the conductive shell 10 are inserted into the corresponding recesses 2624 formed on the two sides after the first and second insulated bodies 20, 40 are assembled, so that the conductive shell 10 is firmly fixed to the assembled first and second insulated bodies 20, 40. The opening 120 of the conductive shell 10 is provided for the cable 60 passing through and for enabling the latching arm support section 264 of the assembled first and second insulated bodies 20, 40 to closely support the back of the spring latching arm 18 (see FIG. 6B) of the conductive shell 10. At the same time, as illustrated in FIG. 7C, the plurality of grounding fingers 12 on the top and bottom surfaces of the conductive shell 10 are extended into the plurality of apertures 224, 424 of the first and second flat portion 22, 42 of the assembled first and second insulated bodies 20, 40, thereby elastically contact the backs of the elastic contact sections 302, 502 of the plurality of specific terminals 30, 50 within the assembled first and second insulated bodies 20, 40, wherein the specific terminals 30, 50 as actual grounding terminals are soldered to be electrically connected with the corresponding grounding wires 64 included in the cable 60 so as to establish a shielding protection for the cable connector 1 to prevent an external signal interferences such as ESD or EMI.

Please refer to FIGS. 6E and 6F, when the cover 70 is further attached to the conductive shell 10, the cover 70 is provided to be disposed on the rear-end of the assembled first and second insulated bodies 20, 40 to cover the accommodating space 228 and isolate the cable 60 and all terminals 30, 50 (see FIG. 6C) in the accommodating space 228 from the outside, so as to complete the overall assembling of the cable connector. In the present embodiment the cover 70 is an adhesive and flexible patch, such as a Mylar patch. However, in other embodiments, the cover 70 can be made of plastic or metal in one piece.

Please refer to FIGS. 7A and 7B, which illustrates an electronic device 80 for being inserted into the cable connector 1 to be electrically connected with the cable connector 1. In the present embodiment, the electronic device 80 can be a storage device such as a hard disk, and a notch is formed on the lower right corner of the electronic device 80 to expose a circuit board 82 extending outward, a row of conductive contact pads 822 are formed on the top and bottom surface of the circuit board, and a gap 84 is formed between one a side edge of the circuit board 82 and the side wall of the notch. Regarding the details about the inserting of the cable connector 1 into the electronic device 80, please further refer to the longitudinal cross-sectional view illustrated in FIG. 7C, which illustrates when the circuit board 82 of the electronic device 80 is inserted into the central slot 232 in the cable connector 1, each of the contact pads 822 of the top and bottom surfaces of the circuit board 82 elastically presses and contacts a front-end bending section in each of the elastic contact sections 302, 502 of the top and bottom rows of terminals 30, 50 extended into the central slot 232, besides enabling electrical connection between the contact pads 822 and the terminals 30, 50. At the same time, each of the contact pad 822 applies a counterforce relative to the spring force on each of the front-end bending sections of the elastic contact sections 302, 502 to shift each of the elastic contact sections 302, 502 backward slightly, so as to secure the electrical contact between the back of the elastic contact sections 302, 502 and the grounding fingers 12 of the conductive shell 10 that are extended into the apertures 224, 424.

Please further refer to the lateral cross-sectional view illustrated in the FIG. 7D, which illustrates when the circuit board 82 of the electronic device 80 is inserted with the cable connector 1, the left side wall 26 of the cable connector 1 also enters the gap 84 at the side of the circuit board 82, so that the clamping portion 182 of the spring latching arm 18 on the conductive shell 10 of the cable connector 1 is engaged into the bay 842 in the gap 84. In the meanwhile, the spring latching arm 18 is elastically pressed to shift backward (i.e. towards the inside of the cable connector 1), yet due to the support of the latching arm support section 264 to the back of the spring latching arm 18, it is unlikely to suffer a permanent deformation and is able to spring-back quickly and engage with the bay 842, firmly.

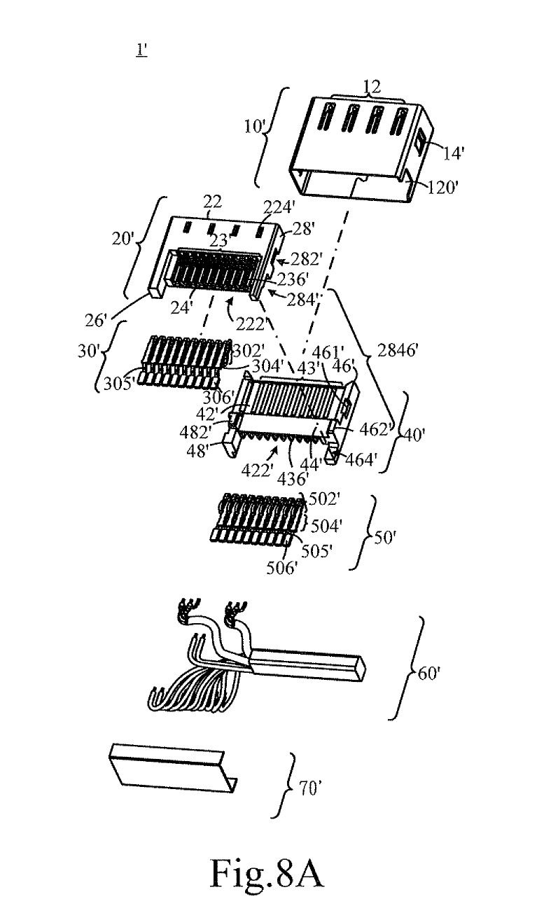

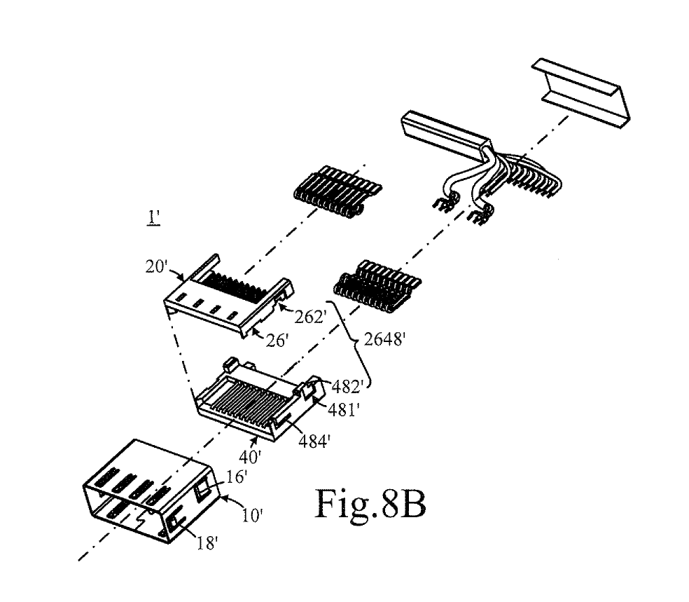

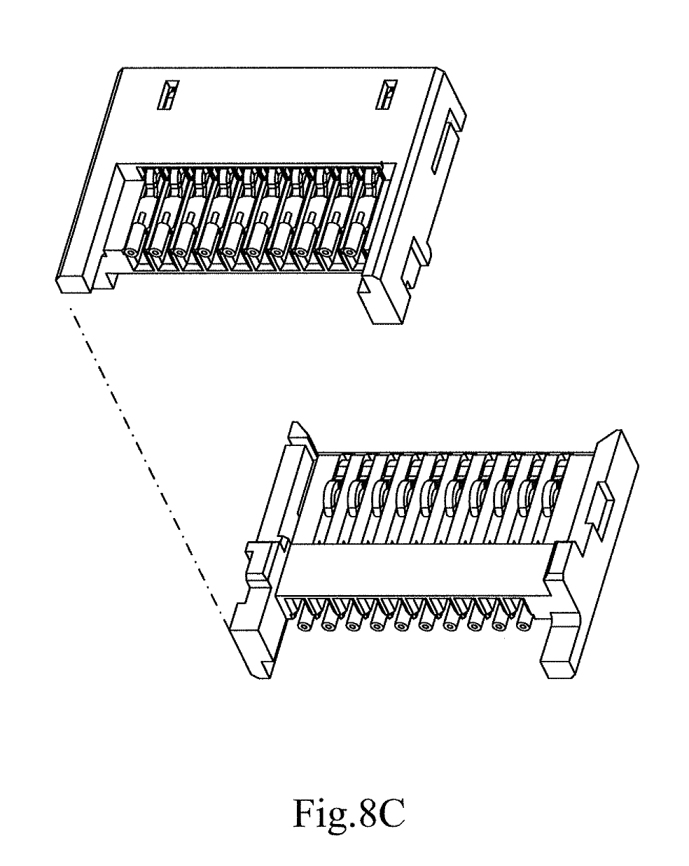

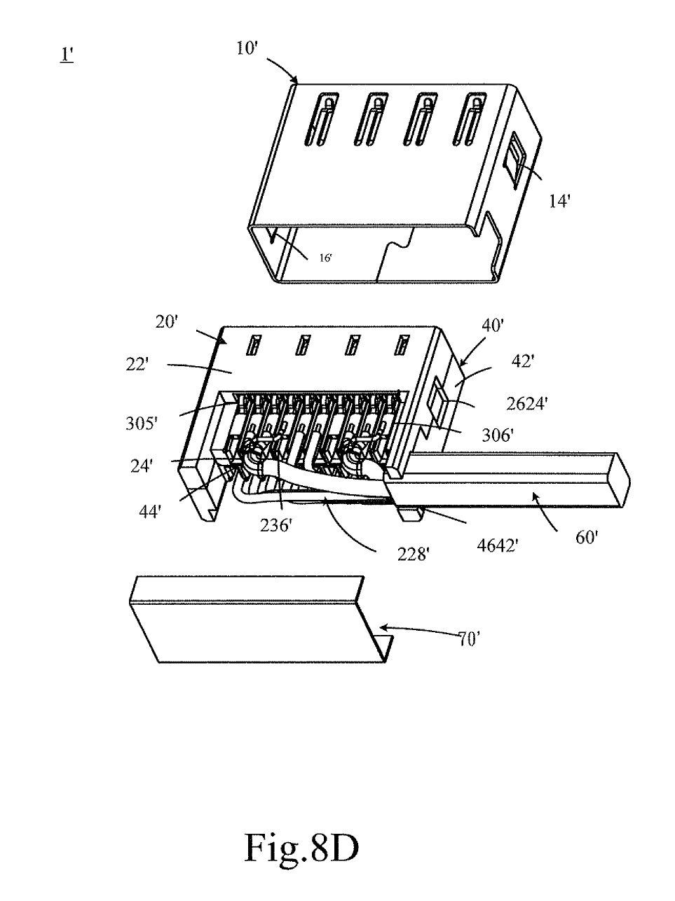

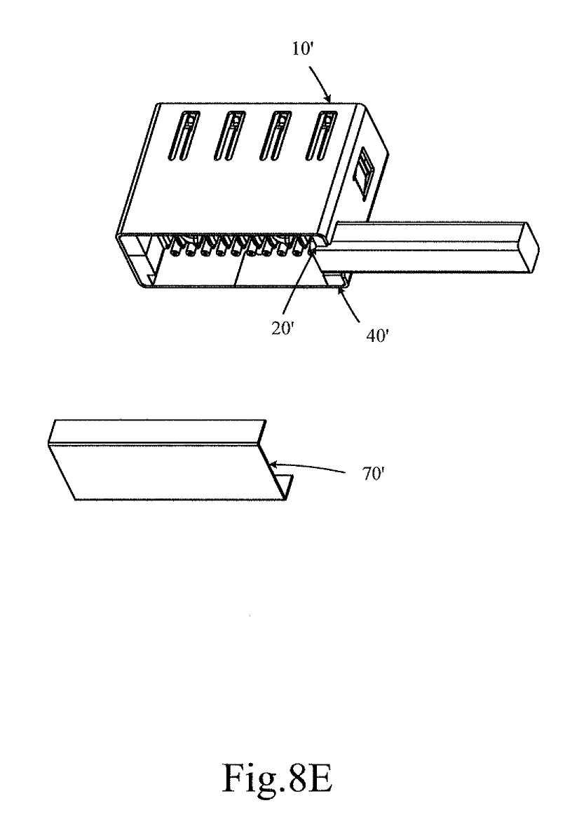

Additionally, as illustrated in FIGS. 8A and 8B, a cable connector 1′ in a sixth preferred embodiment according to the present invention, which comprises a conductive shell 10′, two detachable insulated bodies as a first insulated body 20′ and a second insulated body 40′, a first row of terminals 30′, a second row of terminals 50′, a cable 60′ containing a bunch of wires, and a cover 70′. The cable connector 1′ in the sixth preferred embodiment according to the present invention is distinguished from the cable connector 1 in the fifth embodiment as follows.

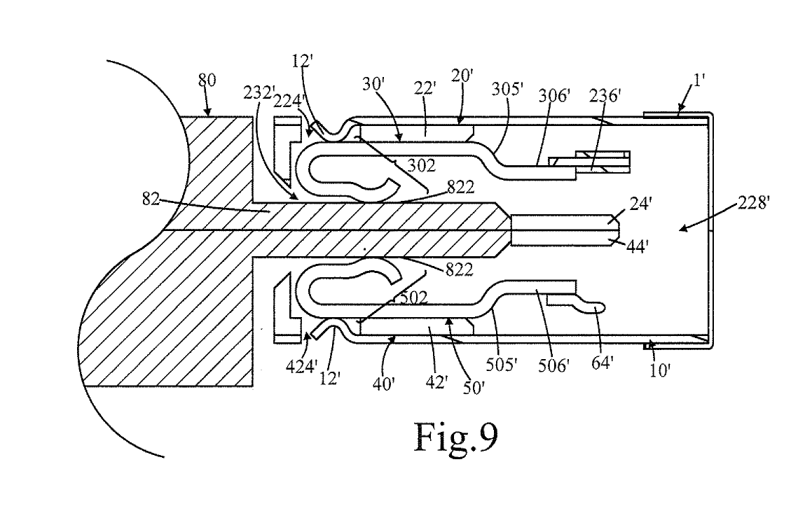

As illustrated in FIGS. 8A and 8B, each of the first and second insulated bodies 20′, 40′ has respectively a first and second flat portion 22′, 42′, and an extending surface 24′, 44′ formed on a surface of each of the flat portion 22′, 42′, and on the other opposed surface, at least one row of apertures 224′, 424″ are formed (see FIG. 9), and a first and a second row of passages 23′, 43′ are formed respectively between the two other opposed surfaces of each of the first and second flat portions 22′, 42′, in a way like arranging the passages 23′, 43′ on the corresponding extending surfaces 24′, 44′ of the flat portion 22′, 42′. As illustrated in FIG. 8A, the first insulated body 20′ has two left and right side walls 26′, 28′ respectively formed on two sides of the first flat portion 22′, and a first depression 222′ is defined jointly by the two side walls 26′, 28′ in combination with the extending surface 24′. A notch section 282′ and an opening 284′ are formed in a bottom surface of the right side wall 28′, and as illustrated in Fig. SB, a notch section 262′ is formed on a bottom surface of the left side wall 26′.

As illustrated in FIGS. 8A and 8B, the second insulated body 40′ has two side walls 48′, 46′ formed on both sides of the second flat portion 42′, and a second depression 422′ is defined jointly by the two side walls 46′, 48′ in combination with the extending surface 44′. As illustrated in FIG. 8A, a notch section 461′, a protrusive section 462′ and an opening 464′ are formed on the top surface of the right side wall 46′. The protrusive section 462′ can be accommodated into the opening 284′ in the right side wall 28′ of the first insulated body 20′ to form an engaging unit 2846′. The notch section 461′ in the right side wall 46′ corresponds to the notch section 282′ in the right side wall 28′ of the first insulated body. As illustrated in FIG. 8B, a notch section 481, a protrusive section 482′ and a latching arm support section 484′ having a lateral elasticity are formed in a top surface of the left side wall 48′ of the second insulated body 40′, wherein the notch section 481′ is formed in an outside surface of the protrusive section 482′. Both the notch section 481′ and the protrusive section 482′ of the left side wall 48′ are opposite to the notch section 262′ of the left side wall 26′ of the first insulated body 20′, wherein the protrusive section 482′ can be accommodated into the notch section 262′ of the left side wall 26′ of the first insulated body 20′ so as to form another engaging unit 2648′. The latching arm support section 484′ of the second insulated body is provided to press and support the spring latching arm 18′ of the conductive shell 10′.

As illustrated in FIG. 8A, two opposed cornered slots 236′, 436′ are formed on both sidewalls of each of the first and second row of passages 23′, 43′ of the first and second insulated bodies 20′, 40′ of the cable connector 1′ according to the sixth preferred embodiment, and a connect section 305′, 505′ having different levels is formed between the soldering sections 306′, 506′. As further illustrated in FIGS. 8D and 9, the connect section 305′, 505′ having different levels are operable to make each of the left and right sides of the soldering section 306′, 506′ of each of the terminals 30′, 50′ respectively abut against each of the corresponding cornered slots 236′, 436′ formed on both sidewalls of the corresponding passage 23′, 43′, so as to prevent the soldering material from flowing to the adjacent terminals 30′, 50′and therefore causes a shorting circuit while the soldering sections 306′, 506′ of each of the terminals 30′, 50′ are soldered to the corresponding wires such as the grounding wires 64′, the completed soldering is as illustrated in FIG. 8C.

As illustrated in FIGS. 8A and 8B, after the first and second insulated bodies 20′, 40′ of the cable connector 1′ in the sixth preferred embodiment are assembled, by engaging the notch section 262′, the opening 284′ and the protrusive sections 482′, 462′ included in the engaging units 2648′, 2846′ to each other, the first and second insulated bodies 20′, 40′ are assembled. In the meanwhile, a recess 2624′ is formed on the notch sections 262′, 282′ and the notch sections 481′, 461′ of the first and second insulated bodies 20′, 40′ (as illustrated in FIG. 8D). A through hole 4642′ (as illustrated in FIG. 8D) for the cable 60′ passing through is defined jointly by joining up and down the upper and lower two openings 284′, 464′.

Please refer to FIGS. 8D and 9, when the assembling of the first and second insulated bodies 20′, 40′ are completed, the two extending surfaces 22′, 24′ of the first and second insulated bodies 20′, 40′ are attached back to back to each other and form an accommodating space 228′ in combination with the plurality of side walls 26′, 28′, 46′ and 48′ of the first and second insulated bodies 20′, 40′ to accommodate the soldering between the soldering sections 306′, 506′ of the upper and lower terminals 30′, 50′ and the cable 60′. Meanwhile, as illustrated in FIG. 9, the first row of passages 23′ and second row of passages 43′ of the first and second insulated bodies 20′, 40′ are opposite to each other in an alternative arrangement. A central slot 232′ is defined between the first row of passages 23′ and the second row of passages 43′, so that each of the elastic contact sections 302′, 502′ of the first and second row of terminals 30′, 50′ is extended into the central slot 232′. The backs of the elastic contact sections 302′, 502′ correspond to the apertures 224′, 424′, and the apertures 224′, 424′ respectively extends through the corresponding passages 23′, 43′, perpendicularly. 101251 Please refer to FIG. 8D, when the conductive shell 10′ is further disposed to the assembled first and second insulated bodies 20′, 40′, the two opposite extending securing portions 14′, 16′ (see FIG. 8B) of the conductive shell 10′ are inserted into the corresponding recesses 2624′ formed on both sides after the first and second insulated bodies 20′, 40′ are assembled, so that the conductive shell 10′ is firmly fixed to the assembled first and second insulated bodies 20′, 40′. The opening 120′ of the conductive shell 10′ is provided for the cable 60′ passing through. Meanwhile, as illustrated in FIG. 8B, the latching arm support section 264′ of the assembled first and second insulated bodies 20′, 40′ closely supports the back of the spring latching arm 18′ of the conductive shell 10. And as illustrated in FIG. 9, the plurality of grounding fingers 12′ on the top and bottom surfaces of the conductive shell 10′ are extended into the plurality of apertures 224′, 424′ of the first and second flat portion 22′, 42′ of the assembled first and second insulated bodies 20′, 40′, and thereby electrically contact with the backs of the elastic contact sections 302′, 502′ of the plurality of specific terminals 30′, 50′ within the assembled first and second insulated bodies 20′, 40′, and the specific terminals 30′, 50′ as actual grounding terminals are soldered to be electrically connected with the corresponding grounding wires 64′ included in the cable 60′ so as to establish a shielding protection for the cable connector 1′ to prevent external signal interferences such as ESD or EMI. Illustrated in FIG. 8E is the assembled first and second insulated bodies 20′, 40′ having the conductive shell 10′ and the cover 70′ sequentially assembled thereto.

Please further refer to a longitudinal cross-sectional view illustrated in FIG. 9, when the circuit board 82 of an electronic device 80 as illustrated in FIG. 7A is inserted into the central slot 232′ of the cable connector 1′, a top end of the circuit board 82 is approaching the two extending surfaces 24′, 44′, and each of the contact pads 822 of the top and bottom surfaces of the circuit board 82 elastically presses and contacts a front-end bending section in each of the elastic contact sections 302′, 502′ of the top and bottom rows of terminals 30′, 50′ extended into the central slot 232′, besides enabling electrical connection between the contact pads 822 and the terminals 30′, 50′. At the same time, each of the contact pad 822 applies a counterforce relative to the spring force on each of the front-end bending sections of the elastic contact sections 302′, 502′ to shift each of the elastic contact sections 302′, 502′ backward slightly, so as to secure the electrical contact between the backs of the elastic contact sections 302′, 502′ and the grounding fingers 12′ of the conductive shell 10′ extended into the apertures 224′, 424′.

Additionally, in the present sixth embodiment, other components and operations that are similar to those in the fifth embodiment are not discussed. Through a plurality of detachable insulated bodies, the cable connectors in the fifth and sixth embodiments according to the present invention allow simultaneous or one-by-one processing of different rows of terminals, which facilitates and quickens the assembling of cable connectors, and in the case one of the terminal has irreparable problems, it is only required to replace the corresponding insulated body. Therefore, this will brings an easy repair, a better yield rate and a lowered manufacturing cost.

It should be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector comprising:
a plurality of rows of terminals, each terminal of which has an elastic contact section, at least one retaining section and a soldering section;
at least one insulated body forming a flat portion which has a first end, a second end opposed to the first end, a central slot formed inwardly from the first end of the flat portion, and a plurality of rows of passages formed between the first end and the second end to correspondingly accommodate the rows of terminals, wherein the central slot is provided to accommodate a portion of an electronic device therein, and each of the elastic contact sections of the rows of terminals is extended into the central slot to electrically contact with the electronic device; and
a conductive shell disposed outside the at least one insulated body and provided with at least one grounding finger which is extended toward at least one of the passages of the at least one insulated body to electrically contact with the corresponding terminal accommodated within the at least one of the passages.

2. The cable connector as claimed in claim 1, wherein the at least one insulated body is a first insulated body, and the cable connector further comprises a second insulated body corresponding to the second end of the first insulated body, and a depression is defined jointly by two opposed side walls of the first insulated body and the flat portion to accommodate the second insulated body, and a portion of the second insulated body is provided to support the soldering sections of the corresponding terminals accommodated in the rows of passages.

3. The cable connector as claimed in claim 2, wherein the second insulated body is disposed between the first insulated body and the conductive shell and has two opposed side walls, each of which is formed with an extending surface to support the soldering sections of the corresponding terminals extending outwardly from respective ends of the corresponding passages of the first insulated body, wherein at least one of the side walls of the second insulated body is engaged to the flat portion of the first insulated body by a first engaging unit, and the conductive shell has at least one securing portion to be engaged to the second insulated body.

4. The cable connector as claimed in claim 2, wherein the second insulated body is disposed on the first insulated body and has a plurality of supporting bumps formed on an end of the second insulated body and inserted into the corresponding passages of the flat portion to support the soldering sections of the corresponding terminals accommodated in the corresponding passages, wherein the two opposed side walls of the second insulated body are engaged to the two opposed side walls of the first insulated body by at least one engaging unit which comprises at least one pair of structurally complementary protrusive section and notch section, and the conductive shell has at least one securing portion to be engaged onto the corresponding side wall of the first insulated body.

5. The cable connector as claimed in claim 1, wherein the soldering section of the corresponding terminal accommodated in the at least one of the passages electrically contacts with the at least one grounding finger of the conductive shell.

6. The cable connector as claimed in claim 1, wherein the conductive shell has at least one securing portion to be engaged onto a side wall of the at least one insulated body.

7. The cable connector as claimed in claim 1, wherein the conductive shell is provided to electrically shield the cable connector, and the at least one grounding finger of the conductive shell is extended into a corresponding aperture of the at least one insulated body to electrically contact with the elastic contact section of the corresponding terminal, and at least one securing portion is formed on the conductive shell to be engaged to the first end of the at least one insulated body.

8. The cable connector as claimed in claim 1, further comprising a cover forming a plurality of side walls which is combined with the conductive shell to jointly define an accommodating space so as to provide an electrical connection between the soldering sections of rows of terminals and a corresponding cable, wherein at least one of the side walls of the cover is engaged to the conductive shell so that a side of the cover is combined with a side wall of the conductive shell to jointly define a through hole for the corresponding cable passing through.

9. The cable connector as claimed in claim 3, further comprising a cover which has a plurality of side walls respectively formed on both sides of the cover and is combined with the conductive shell to jointly define an accommodating space provided for an electrical connection between the soldering sections of the rows of terminals and a corresponding cable, wherein by a second engaging unit, at least one of the side walls of the cover is engaged onto one of the side walls of the first insulated body to dispose the second insulated body and the conductive shell in between the first insulated body and the cover, and each of the engaging units comprises at least one pair of structurally complementary protrusive section and notch section, so that one of the side walls of the cover is combined with one of the side walls of the first insulated body to jointly define a through hole provided for the corresponding cable passing through.

10. The cable connector as claimed in claim 1, further comprising a cover which has a plurality of side walls respectively formed on both sides of the cover and is combined with the conductive shell to jointly define an accommodating space provided for an electrical connection between the soldering sections of the rows of terminals and a corresponding cable, wherein by at least one engaging unit, at least one of the side walls of the cover is engaged onto one of side walls formed with the at least one insulated body to dispose the conductive shell in between the at least one insulated body and the cover, and the at least one engaging unit comprises at least one pair of structurally complementary protrusive section and notch section so that one of the side walls of the cover is combined with one of the side walls of the first insulated body to jointly define a through hole provided for the corresponding cable passing through.

11. The cable connector as claimed in claim 1, wherein an undulating connecting section is formed between the at least one retaining section and the soldering section in each of the terminals so that two sides of the soldering section respectively abut against two opposed cornered slots formed on both sidewalls of the corresponding passage to support the soldering section of the corresponding terminal.

12. A cable connector comprising:
a plurality of rows of terminals, each terminal of which has an elastic contact section, at least one retaining section and a soldering section;
a first insulated body forming a flat portion which has a first end, a second end opposed to the first end, a central slot formed inwardly from the first end, and a plurality of rows of passages formed between the first end and the second end to correspondingly accommodate the rows of terminals, wherein each of the elastic contact sections of the rows of terminals is extended into the central slot to electrically contact with an electronic device; and
a second insulated body disposed on the second end of the first insulated body and having a portion provided to support an electrical connection between the soldering sections of the corresponding terminals accommodated in the rows of passages and a corresponding cable.

13. The cable connector as claimed in claim 12, wherein a spring latching arm is disposed on one of side walls formed on the first insulated body and is engaged to a corresponding hole formed on the electronic device.

14. The cable connector as claimed in claim 12, wherein the second insulated body is engaged onto two opposed side walls of the first insulated body or the flat portion.

15. The cable connector as claimed in claim 12, wherein a portion of the second insulated body comprises a plurality of supporting bumps formed on an end of the second insulated body and inserted into the corresponding passages of the flat portion to support the soldering sections of the corresponding terminals accommodated in the corresponding passages.

16. The cable connector as claimed in claim 12, wherein a portion of the second insulated body comprises at least one extending surface formed on a side wall of the second insulated body to support the soldering sections of the corresponding terminals that are extended outward respective ends of the corresponding passages.

17. The cable connector as claimed in claim 12, further comprising a conductive shell engaged onto the first insulated body or the second insulated body and formed with at least one grounding finger extended toward at least one of the passages of the at least one insulated body to electrically connect with the corresponding terminal accommodated in the at least one of the passages.

18. An electrical apparatus comprising the cable connector as claimed in claim 1.

19. A cable connector for electrical connection with an electronic device, comprising:
a plurality of rows of terminals, each terminal of which has an elastic contact section, at least one retaining section and a soldering section;
a plurality of insulated bodies, each having a flat portion which is formed with an extending surface and a row of passages connected with the extending surface and accommodating corresponding one of the rows of terminals in which the soldering sections are exposed outward the extending surface; and
at least one engaging unit disposed on at least one of the insulated bodies, provided to assemble the insulated bodies to jointly define a central slot which accommodates a portion of the electronic device in between the flat portions of the insulated bodies so that the elastic contact sections of the rows of terminals are extended into the central slot to electrically contact with the electronic device.

20. The cable connector as claimed in claim 19, wherein each of the insulated bodies has two side walls formed on both sides of the flat portion thereof and combined with the extending surface to jointly define a depression to allow an electrical connection between the soldering sections of rows of terminals and a corresponding cable.

21. The cable connector as claimed in claim 20, wherein the at least one engaging unit comprises a protrusive section and a notch section which are complementary structurally and respectively formed on one of the side walls in the at least one of the insulated bodies.

22. The cable connector as claimed in claim 20, wherein one of the side walls of one of the insulated bodies, and one of the side walls of another one of the insulated bodies correspond to each other and individually form an opening, when the insulated bodies are assembled, the openings jointly define a through hole for the corresponding cable passing through.

23. The cable connector as claimed in claim 19, wherein an undulating connecting section is formed between the at least one retaining section and the soldering section in each of the terminals, so that two sides of the soldering section respectively abut against two opposed cornered slots formed on both sidewalls of the corresponding passage, and the passage is arranged on the extending surface of the flat portion.

24. The cable connector as claimed in claim 23, wherein after the insulated bodies are assembled, the extending surfaces of the insulated bodies are attached to each other back-to-back and are combined with the side walls of the insulated bodies to jointly define an accommodating space provided for accommodating a connection between the soldering sections of rows of terminals and a corresponding cable.

25. The cable connector as claimed in claim 19, wherein a coplanar connection is formed jointly by the at least one retaining section and the soldering section in each of the terminals, and the soldering sections are extended from the corresponding passages to the extending surface of the flat portion.

26. The cable connector as claimed in claim 25, wherein after the insulated bodies are assembled, the extending surfaces of the insulated bodies are opposed apart away from each other so that an accommodating space is defined between the extending surfaces to accommodate a connection between the soldering sections of rows of terminals and a corresponding cable.

27. The cable connector as claimed in claim 24, further comprising a cover for covering the accommodating space.

28. The cable connector as claimed in claim 19, further comprising a conductive shell forming a securing portion and a spring latching arm, wherein the spring latching arm is engaged onto a hole in the electronic device, and the conductive shell is disposed on the assembled insulated bodies, a latching aim support section is formed on one of the insulated bodies to support the spring latching arm of the conductive shell, and the securing portion of the conductive shell is inserted into a recess formed on the at least one engaging unit.

29. The cable connector as claimed in claim 19, further comprising a conductive shell forming at least one securing portion, a spring latching arm and at least one grounding finger, wherein the spring latching arm is engaged to a hole in the electronic device, and the conductive shell is disposed on the assembled insulated bodies, the insulated bodies is assembled by at least one engaging unit to define a recess for insertion of the securing portion of the conductive shell, and one of the insulated bodies has a latching arm support section provided to support the spring latching arm of the conductive shell, and at least one aperture provided for the at least one grounding finger extending therein to electrically contact with the elastic contact section of at least one of the terminals of the insulated bodies.

30. A cable connector comprising:
a plurality of rows of terminals, each terminal of which has an elastic contact section, at least one retaining section and a soldering section;
a plurality of insulated bodies each forming at least one aperture, an extending surface, and a row of passages accommodating corresponding one of the rows of terminals in which the soldering section are exposed outward the extending surface, and at least one of the passages connected to the at least one aperture so that the elastic contact section of the corresponding terminal in the at least one passage corresponds to the at least one aperture; and
a conductive shell forming a spring latching arm and at least one grounding finger, and disposed on the insulated bodies which are assembled together, so that the at least one grounding finger is extended into the at least one aperture to contact with the corresponding elastic contact section in the at least one aperture.

31. The cable connector as claimed in claim 30, wherein the row of passages of each of the insulated bodies is connected to the extending surface, and a latching arm support section is formed on at least one of the insulated bodies, and the insulated bodies are assembled together to form a recess, so that when the conductive shell is disposed on the assembled insulated bodies, at least one securing portion formed on the conductive shell is inserted into the recess, and the spring latching aim of the conductive shell is supported by the latching arm support section.
